(19) United States
(12) Patent Application Publication
(10) Pub. No.: US 2025/0138570 A1
(43) Pub. Date: May 1, 2025

(54) PHYSICAL CODING SUBLAYER DATAPATH SYSTEMS AND METHODS WITH DETERMINISTIC LATENCY

(71) Applicant: Lattice Semiconductor Corporation, Hillsboro, OR (US)

(72) Inventors: Wolfgang Roethig, San Jose, CA (US); Ashutosh Dikshit, Saratoga, CA (US); Fulong Zhang, Cupertino, CA (US); John Ming Thendean, Pleasanton, CA (US)

(21) Appl. No.: 18/924,915

(22) Filed: Oct. 23, 2024

Related U.S. Application Data
(60) Provisional application No. 63/593,204, filed on Oct. 25, 2023.

(51) Int. Cl. G06F 1/06

(52) U.S. Cl. CPC G06F 1/06

(57) ABSTRACT

Various techniques are provided to implement physical coding sublayer (PCS) datapath systems and methods with deterministic latency. In one example, a PCS circuit includes an elastic buffer configured to operate according to a read clock associated with a read domain and a write clock associated with a write domain. The elastic buffer is configured to generate a first signal associated with the write domain and indicative of a first difference between a read pointer and a write pointer. The elastic buffer is further configured to generate a second signal associated with the read domain and indicative of a second difference between the read pointer and the write pointer. The PCS circuit further comprises a logic circuit configured to determine a phase difference between the read clock and the write clock based on the first signal and the second signal. Related methods and systems are provided.

### CROSS-REFERENCE TO RELATED APPLICATION

This application claims priority to and the benefit of U.S. Provisional Patent Application No. 63/593,204 filed Oct. 25, 2023 and entitled “PHYSICAL CODING SUBLAYER DATAPATH SYSTEMS AND METHODS WITH DETERMINISTIC LATENCY,” which is hereby incorporated by reference in its entirety.

### TECHNICAL FIELD

The present invention relates generally to programmable logic devices and, more particularly, to physical coding sublayer datapath systems and methods with deterministic latency.

### BACKGROUND

Programmable logic devices (PLDs) (e.g., field programmable gate arrays (FPGAs), complex programmable logic devices (CPLDs), field programmable systems on a chip (FPSCs), or other types of programmable devices) may be configured with various user designs to implement desired functionality. Typically, the user designs are synthesized and mapped into configurable resources, including by way of non-limiting examples programmable logic gates, look-up tables (LUTs), embedded hardware, interconnections, and/or other types of resources, available in particular PLDs. Physical placement and routing for the synthesized and mapped user designs may then be determined to generate configuration data for the particular PLDs. The generated configuration data is loaded into configuration memory of the PLDs to implement the programmable logic gates, LUTs, embedded hardware, interconnections, and/or other types of configurable resources.

### SUMMARY

In one or more embodiments, a physical coding sublayer circuit comprises an elastic buffer configured to operate according to a read clock associated with a read domain and a write clock associated with a write domain. The elastic buffer is configured to generate a first signal associated with the write domain and indicative of a first difference between a read pointer and a write pointer. The elastic buffer is further configured to generate a second signal associated with the read domain and indicative of a second difference between the read pointer and the write pointer. The physical coding sublayer circuit further comprises a logic circuit configured to determine a phase difference between the read clock and the write clock based on the first signal and the second signal.

In one or more embodiments, a method includes generating, by an elastic buffer of a physical coding sublayer circuit, a first signal associated with a write domain and indicative of a first difference between a read pointer and a write pointer. The elastic buffer operates according to a read clock associated with a read domain and a write clock associated with the write domain. The method further comprises generating, by the elastic buffer, a second signal associated with the read domain and indicative of a second difference between the read pointer and the write pointer. The method further comprises determining, by a logic circuit, a phase difference between the read clock and the write clock based on the first signal and the second signal.

### BRIEF DESCRIPTION OF THE DRAWINGS

FIG. 1 illustrates a block diagram of a PLD in accordance with one or more embodiments of the present disclosure.

FIG. 2 illustrates a block diagram of a programmable logic block of a PLD in accordance with one or more embodiments of the present disclosure.

FIG. 3 illustrates a design process for a PLD in accordance with one or more embodiments of the present disclosure.

FIG. 4 illustrates an example datapath architecture of a multi-protocol physical coding sublayer circuit in accordance with one or more embodiments of the present disclosure.

FIG. 5 illustrates an example flow associated with a datapath architecture of a physical coding sublayer circuit in accordance with one or more embodiments of the present disclosure.

FIG. 6 illustrates a component of the datapath architecture of FIGS. 4 and/or 5 in accordance with one or more embodiments of the present disclosure.

FIG. 7 illustrates a block diagram of a transmit-side component having a transmit-side elastic buffer and a transmit-side gearbox in accordance with one or more embodiments of the present disclosure.

FIG. 8 illustrates a block diagram of a receive-side component having a receive-side elastic buffer and a receive-side gearbox in accordance with one or more embodiments of the present disclosure.

FIG. 9 illustrates a transmit gearbox in accordance with one or more embodiments of the present disclosure.

FIG. 10 illustrates a receive gearbox in accordance with one or more embodiments of the present disclosure.

FIGS. 11A and 11B illustrate an example of an elastic buffer having deterministic latency in accordance with one or more embodiments of the present disclosure.

FIG. 12 illustrates a block diagram of a system for facilitating deterministic latency in accordance with one or more embodiments of the present disclosure.

FIG. 13 illustrates a flow diagram of an example process for facilitating deterministic latency in accordance with one or more embodiments of the present disclosure.

FIG. 14 illustrates a timing diagram and associated dataflow and control signals associated with a block encoder for facilitating deterministic latency in accordance with one or more embodiments of the present disclosure.

FIG. 15 illustrates a timing diagram and associated dataflow and control signals associated with a block decoder for facilitating deterministic latency in accordance with one or more embodiments of the present disclosure.

FIG. 16 illustrates a timing diagram and associated dataflow and control signals associated with a block encoder for facilitating deterministic latency in accordance with one or more embodiments of the present disclosure.

FIG. 17 illustrates a timing diagram and associated dataflow and control signals associated with a block decoder for facilitating deterministic latency in accordance with one or more embodiments of the present disclosure.

FIGS. 18A through 18E illustrates an example of a block encoder in a transmit datapath in accordance with one or more embodiments in the present disclosure.

FIGS. 19A through 19D illustrates an example of a block decoder in a receive datapath in accordance with one or more embodiments in the present disclosure.

Embodiments of the present disclosure and their advantages are best understood by referring to the detailed description that follows. It should be appreciated that like reference numerals are used to identify like elements illustrated in one or more of the figures.

### DETAILED DESCRIPTION

In accordance with embodiments disclosed herein, various techniques are provided to implement a datapath architecture of a physical coding sublayer (PCS) with deterministic latency. Synchronous datapath architectures having deterministic latency may be utilized to support latency requirements associated with various existing standards and protocols, such as 5G protocols which may involve class C latency, as well as contemplated future protocols, such as 6G protocols, that may have even more stringent requirements for latency.

In some embodiments, such a datapath architecture may be a fully synchronous datapath architecture for the PCS where the only clock domain crossings are implemented in elastic buffers with identical clock rates at a read port and a write port. Such a datapath has deterministic latency. In this regard, other components of the PCS, such as a gearbox, is devoid of any clock domain crossings (e.g., no clock domain crossing from a read domain to a write domain and no clock domain crossing from the write domain to the read domain). The elastic buffers mitigate clock skew, especially at the transition between lane-based logic and link-based logic. The lane-based logic may be a relatively small circuitry in the PCS that faces a physical medium attachment (PMA) sublayer. The linked-based logic may be a larger circuitry that spans across multiple lanes facing a media access control (MAC) sublayer. In a datapath architecture according to various embodiments, gearboxes may be utilized for data format conversion, such as from 66 bits to 64 bits for example, facing the PMA and up-or-down shifting (e.g., widening a bus by a factor of 2 while reducing the clock rate by the same factor) at an interface to a programmable logic core that supports only lower clock rates. In some cases, since the gearbox circuitry resides in an isochronous clock domain in the datapath architecture, a state/status of the gearbox circuitry can be monitored by extra logic in the same clock domain without uncertainty. Therefore, the latency of the datapath is deterministic.

The extra logic may be implemented using logic circuitry connected to a set of input/output (I/O) ports for latency monitoring. The ports may be connected to registers (e.g., software-readable registers) and signals stored in the registers for monitoring by the logic circuitry. In an aspect, such logic circuitry for monitoring latency may also be referred to as a latency monitoring circuit. For such latency monitoring, the logic circuitry may capture the state/status of the gearbox circuitry and determine an average over time. For example, the logic circuitry may run software that can issue read commands to capture the state/status periodically, in response to user input, and/or other trigger.

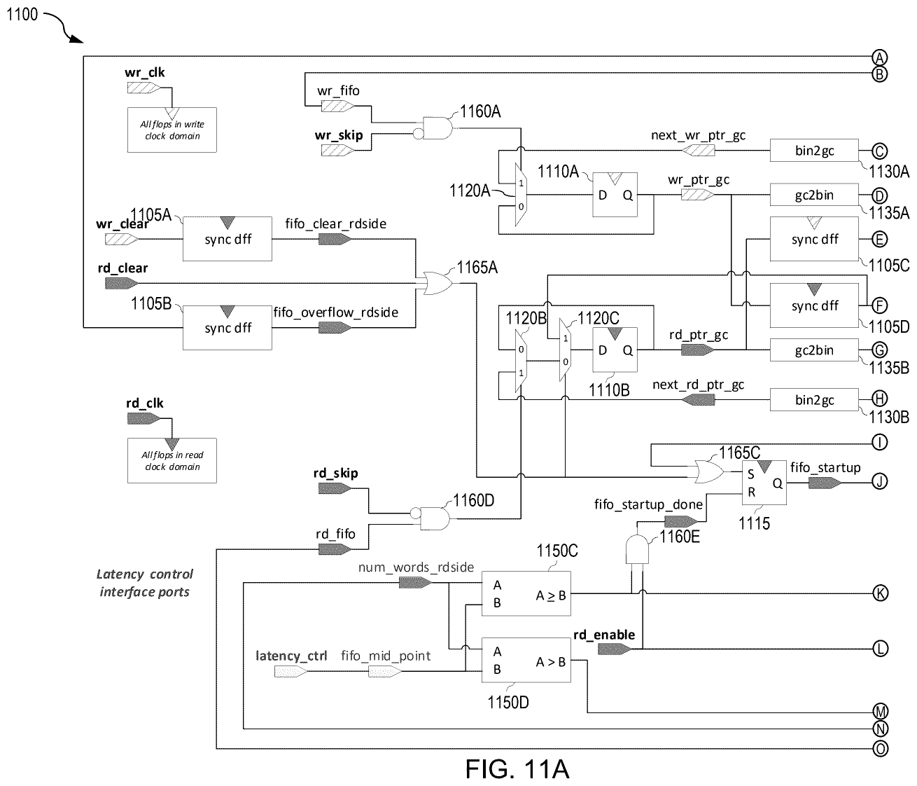

In some embodiments, the state/status of the gearbox circuitry may be determined based on a set of signals generated by operation of one or more elastic buffers coupled to the gearbox circuitry, as further described herein. In such embodiments, an elastic buffer may have control ports and observation ports to facilitate the latency monitoring. The logic circuitry may be connected to a set of I/O ports (e.g., the control and observation ports) that provide the set of signals. The elastic buffer may operate according to a read clock and a write clock. In some aspects, the read and write clocks have the same clock rate. For example, data for latency monitoring may be retrieved from these ports and stored (e.g., in registers) and/or processed for latency purposes. Such signals for latency monitoring may include, by way of non-limiting examples, “latency_ctrl”, “fifo_mid_point”, “num_words_rdside”, and/or “num_words_wrside” shown in and described with respect to FIGS. 11A and/or 11B for example. In some cases, the “latency_ctrl” and “fifo_mid_point” signals may be referred to as control signals and provided at control ports, since these signals may be set (e.g., by a user, a manufacturer of the elastic buffer, etc.). In some cases, the “num_words_rdside” and “num_words_wrside” signals may be referred to as observation signals and provided at observation ports, since these signals provide a state of the elastic buffer as the elastic buffer is operated. In this regard, the logic circuitry may run software that can issue read commands to capture the state/status of the control ports and observation ports periodically, in response to user input, and/or other trigger. The state/status may be averaged over time. The logic circuitry may determine (e.g., infer) a phase difference between the read clock and the write clock based on a difference between the state/status at the elastic buffer's write port and the state/status at the elastic buffer's read port. Such a difference may be based on a difference between (e.g., a subtraction of) a signal associated with the state/status at the write port and a corresponding signal associated with the state/status at the read port. In some cases, the signal at the read port may include “num_words_rdside” and the corresponding signal at the write port may include “num_words_wrside”.

In some embodiments, the datapath utilizes dataflow control signals, such as ready and valid signals, similar to or same as those utilized in, for example, the advanced extensible interface (AXI) streaming interface. Usage of such control signals facilitates implementation of a gearbox in a single clock domain. The state of a gearbox is deterministic. For example, a 4-to-1 gearbox goes through four period states and a 33-to-32 gearbox goes through 32 periodic states. By controlling a start of data transfer at a known initial state and running the gearbox by a single clock, the state of the gearbox at any point in time is predictable. In some embodiments, the elastic buffers have the same clock rate at both the read and write ports. Since the elastic buffers have the same clock rate at both the read and write ports, a phase between the clocks is constant although it is not known a priori. By adding control ports and observation ports to each elastic buffer (e.g., associated with “latency_ctrl”, “fifo_mid_point”, “num_words_rdside”, and “num_words_wrside” for each elastic buffer), a nominal distance between the read and write pointer (e.g., the nominal latency of the elastic buffer) can be controlled for each elastic buffer. An actual distance can be seen in both the read and write clock domain (e.g., the actual latency from two observation points). With data from both clock domains, a phase between the clocks can be determined, thus eliminating uncertainty.

The datapath in a PCS associated with a serializer/deserializer (SERDES) involves multiple clock domain crossings. In this regard, each clock domain crossing from one clock domain to another clock domain shown in FIGS. 11A and 11B introduces an uncertainty in the latency of a signal. In some cases, such uncertainty may be especially apparent when clock rates associated with the clock domains are not harmonic. For example, Ethernet 10GBASE-R utilizes 64b/66b blocks (i.e., 66 bit total formed of a 64 bit payload and 2 bit header). As such, it may be desired to serially transmit and receive the data in parallel chunks of, for example, 33 bits or 66 bits and thus an associated clock rate of 1/33 or 1/66, respectively, of the serial data rate. However, SERDES interfaces typically support only bus widths that are powers of 2 (e.g., 8, 16, 32, 64 bits, etc.) or powers of 2 times 5 (e.g., 10, 20, 40 bits, etc.). Since an Ethernet block (e.g., 66 bit in 10GBASE-R, 65 bit or 257 bit in other standards) does not fit in such a format, a gearbox may be necessary which involves format conversion and clock domain crossing in conventional datapath architectures. Using various embodiments, implementing clock domain crossings only in elastic buffers of the datapath may facilitate deterministic latency.

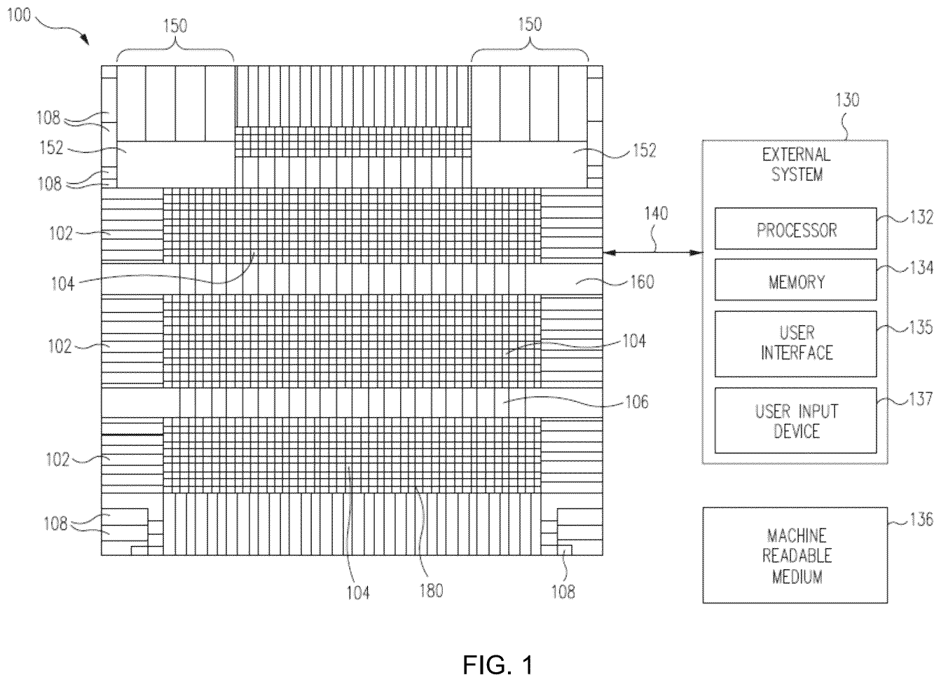

Referring now to the figures, FIG. 1 illustrates a block diagram of a PLD 100 in accordance with one or more embodiments of the present disclosure. In various embodiments, the PLD 100 may be implemented as a standalone device, for example, or may be embedded in a die that contains a system on a chip (SOC), other logic devices, and/or other integrated circuit(s). The PLD 100 (e.g., a field programmable gate array (FPGA), a complex programmable logic device (CPLD), a field programmable system on a chip (FPSC), or other type of programmable device) generally includes input/output (I/O) blocks 102 and logic blocks 104 (e.g., also referred to as programmable logic blocks (PLBs), programmable functional units (PFUs), or programmable logic cells (PLCs)). In some cases, the PLD 100 may generally be any type of programmable device (e.g., programmable integrated circuit) with distributed configuration, which may involve loading configuration data through pins, shifting to appropriate locations in associated fabric, and configuring configuration memory cells. The PLBs may also be referred to as logic blocks, programmable functional units (PFUs), or programmable logic cells (PLCs). In an aspect, the PLBs 104 may collectively form an integrated circuit (IC) core or logic core of the PLD 100. The I/O blocks 102 provide I/O functionality (e.g., to support one or more I/O and/or memory interface standards) for the PLD 100, while the PLBs 104 provide logic functionality (e.g., LUT-based logic) for the PLD 100. Additional I/O functionality may be provided by serializer/deserializer (SERDES) blocks 150 and physical coding sublayer (PCS) blocks 152. The PLD 100 may also include hard intellectual property core (IP) blocks 160 to provide additional functionality (e.g., substantially predetermined functionality provided in hardware which may be configured with less programming than the PLBs 104).

The PLD 100 may include blocks of memory 106 (e.g., blocks of erasable programmable read-only memory (EEPROM), block static RAM (SRAM), and/or flash memory), clock-related circuitry 108 (e.g., clock sources, phase-locked loop (PLL) circuits, delay-locked loop (DLL) circuits, and/or feedline interconnects), and/or various routing resources 180 (e.g., interconnect and appropriate switching circuits to provide paths for routing signals throughout the PLD 100, such as for clock signals, data signals, control signals, or others) as appropriate. In general, the various elements of the PLD 100 may be used to perform their intended functions for desired applications, as would be understood by one skilled in the art.

For example, certain of the I/O blocks 102 may be used for programming the memory 106 or transferring information (e.g., various types of user data and/or control signals) to/from the PLD 100. Other of the I/O blocks 102 include a first programming port (which may represent a central processing unit (CPU) port, a peripheral data port, a serial peripheral interface (SPI) interface, and/or a sysCONFIG programming port) and/or a second programming port such as a joint test action group (JTAG) port (e.g., by employing standards such as Institute of Electrical and Electronics Engineers (IEEE) 1149.1 or 1532 standards). In various embodiments, the I/O blocks 102 may be included to receive configuration data and commands (e.g., over one or more connections) to configure the PLD 100 for its intended use and to support serial or parallel device configuration and information transfer with the SERDES blocks 150, PCS blocks 152, hard IP blocks 160, and/or PLBs 104 as appropriate. In another example, the routing resources 180 may be used to route connections between components, such as between I/O nodes of logic blocks 104. In some embodiments, such routing resources may include programmable elements (e.g., nodes where multiple routing resources intersect) that may be used to selectively form a signal path for a particular connection between components of the PLD 100.

It should be understood that the number and placement of the various elements are not limiting and may depend upon the desired application. For example, various elements may not be required for a desired application or design specification (e.g., for the type of programmable device selected). Furthermore, it should be understood that the elements are illustrated in block form for clarity and that various elements would typically be distributed throughout the PLD 100, such as in and between the PLBs 104, hard IP blocks 160, and routing resources 180 to perform their conventional functions (e.g., storing configuration data that configures the PLD 100 or providing interconnect structure within the PLD 100). For example, the routing resources 180 may be used for internal connections within each PLB 104 and/or between different PLBs 104. It should also be understood that the various embodiments disclosed herein are not limited to programmable logic devices, such as the PLD 100, and may be applied to various other types of programmable devices, as would be understood by one skilled in the art.

An external system 130 may be used to create a desired user configuration or design of the PLD 100 and generate corresponding configuration data to program (e.g., configure) the PLD 100. For example, to configure the PLD 100, the system 130 may provide such configuration data to one or more of the I/O blocks 102, PLBs 104, SERDES blocks 150, and/or other portions of the PLD 100. In this regard, the external system 130 may include a link 140 that connects to a programming port (e.g., SPI, JTAG) of the PLD 100 to facilitate transfer of the configuration data from the external system 130 to the PLD 100. As a result, the I/O blocks 102, PLBs 104, various of the routing resources 180, and any other appropriate components of the PLD 100 may be configured to operate in accordance with user-specified applications.

In the illustrated embodiment, the system 130 is implemented as a computer system. In this regard, the system 130 includes, for example, one or more processors 132 that may be configured to execute instructions, such as software instructions, provided in one or more memories 134 and/or stored in non-transitory form in one or more non-transitory machine readable media 136 (e.g., which may be internal or external to the system 130). For example, in some embodiments, the system 130 may run PLD configuration software, such as Lattice Diamond System Planner software available from Lattice Semiconductor Corporation to permit a user to create a desired configuration and generate corresponding configuration data to program the PLD 100. In this regard, in some cases, the system 130 and/or other external/remote system may be used for factory programming or remote programming (e.g., remote updating) of one or more PLDs (e.g., through a network), such as the PLD 100.

The configuration data may alternatively or in addition be stored on the PLD 100 (e.g., stored in a memory located within the PLD 100) and/or a separate/discrete memory of a system including the PLD 100 and the separate/discrete memory (e.g., a system within which the PLD 100 is operating). In some embodiments, the memory 106 of the PLD 100 may include non-volatile memory (e.g., flash memory) utilized to store the configuration data generated and provided to the memory 106 by the external system 130. During configuration of the PLD 100, the non-volatile memory may provide the configuration data via configuration paths and associated data lines to configure the various portions (e.g., I/O blocks 102, PLBs 104, SERDES blocks 150, routing resources 180, and/or other portions) of the PLD 100. In some cases, the configuration data may be stored in non-volatile memory external to the PLD 100 (e.g., on an external hard drive such as the memories 134 in the system 130). During configuration, the configuration data may be provided (e.g., loaded) from the external non-volatile memory into the PLD 100 to configure the PLD 100.

The system 130 also includes, for example, a user interface 135 (e.g., a screen or display) to display information to a user, and one or more user input devices 137 (e.g., a keyboard, mouse, trackball, touchscreen, and/or other device) to receive user commands or design entry to prepare a desired configuration of the PLD 100. In some embodiments, user interface 135 may be adapted to display a netlist, a component placement, a connection routing, hardware description language (HDL) code, and/or other final and/or intermediary representations of a desired circuit design, for example.

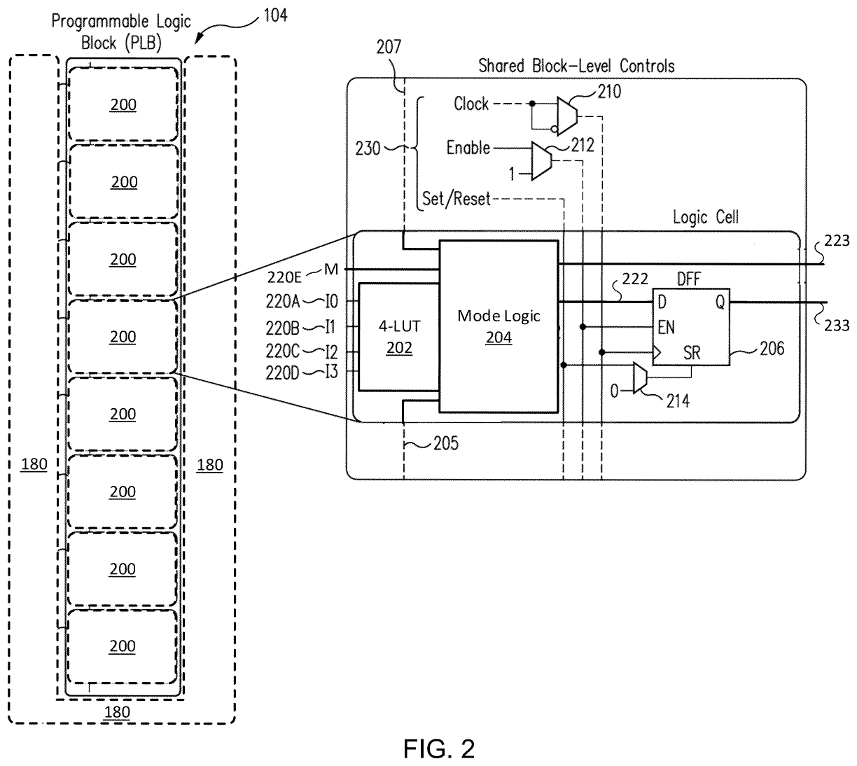

FIG. 2 illustrates a block diagram of a logic block 104 of the PLD 100 in accordance with one or more embodiments of the present disclosure. As discussed, the PLD 100 includes a plurality of logic blocks 104 including various components to provide logic and arithmetic functionality. In the example embodiment shown in FIG. 2, the logic block 104 includes a plurality of logic cells 200, which may be interconnected internally within logic block 104 and/or externally using the routing resources 180. For example, each logic cell 200 may include various components such as: a lookup table (LUT) 202, a mode logic circuit 204, a register 206 (e.g., a flip-flop or latch), and various programmable multiplexers (e.g., programmable multiplexers 212 and 214) for selecting desired signal paths for the logic cell 200 and/or between logic cells 200. In this example, the LUT 202 accepts four inputs 220A-220D, which makes it a four-input LUT (which may be abbreviated as “4-LUT” or “LUT4”) that can be programmed by configuration data for the PLD 100 to implement any appropriate logic operation having four inputs or less. The mode logic 204 may include various logic elements and/or additional inputs, such as an input 220E, to support the functionality of various modes for the logic cell 200 (e.g., including various processing and/or functionality modes). The LUT 202 in other examples may be of any other suitable size having any other suitable number of inputs for a particular implementation of a PLD. In some embodiments, different size LUTs may be provided for different logic blocks 104 and/or different logic cells 200.

An output signal 222 from the LUT 202 and/or the mode logic 204 may in some embodiments be passed through the register 206 to provide an output signal 233 of the logic cell 200. In various embodiments, an output signal 223 from the LUT 202 and/or the mode logic 204 may be passed to the output 223 directly, as shown. Depending on the configuration of multiplexers 210-214 and/or the mode logic 204, the output signal 222 may be temporarily stored (e.g., latched) in the register 206 according to control signals 230. In some embodiments, configuration data for the PLD 100 may configure the output 223 and/or 233 of the logic cell 200 to be provided as one or more inputs of another logic cell 200 (e.g., in another logic block or the same logic block) in a staged or cascaded arrangement (e.g., comprising multiple levels) to configure logic and/or other operations that cannot be implemented in a single logic cell 200 (e.g., operations that have too many inputs to be implemented by a single LUT 202). Moreover, logic cells 200 may be implemented with multiple outputs and/or interconnections to facilitate selectable modes of operation.

The mode logic circuit 204 may be utilized for some configurations of the PLD 100 to efficiently implement arithmetic operations such as adders, subtractors, comparators, counters, or other operations, to efficiently form some extended logic operations (e.g., higher order LUTs, working on multiple bit data), to efficiently implement a relatively small RAM, and/or to allow for selection between logic, arithmetic, extended logic, and/or other selectable modes of operation. In this regard, the mode logic circuits 204, across multiple logic cells 200, may be chained together to pass carry-in signals 205 and carry-out signals 207, and/or other signals (e.g., output signals 222) between adjacent logic cells 200. In the example of FIG. 2, the carry-in signal 205 may be passed directly to the mode logic circuit 204, for example, or may be passed to the mode logic circuit 204 by configuring one or more programmable multiplexers. In some cases, the mode logic circuits 204 may be chained across multiple logic blocks 104.

The logic cell 200 illustrated in FIG. 2 is merely an example, and logic cells 200 according to different embodiments may include different combinations and arrangements of PLD components. Also, although FIG. 2 illustrates a logic block 104 having eight logic cells 200, a logic block 104 according to other embodiments may include fewer logic cells 200 or more logic cells 200. Each of the logic cells 200 of a logic block 104 may be used to implement a portion of a user design implemented by the PLD 100. In this regard, the PLD 100 may include many logic blocks 104, each of which may include logic cells 200 and/or other components which are used to collectively implement the user design.

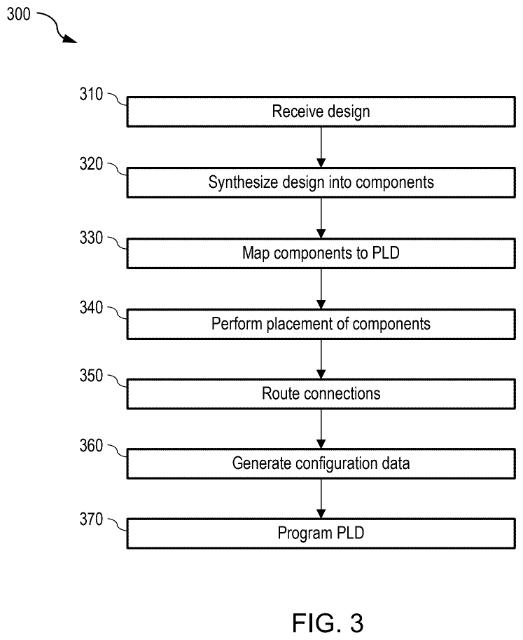

FIG. 3 illustrates a design process 300 for a PLD in accordance with one or more embodiments of the present disclosure. For example, the process of FIG. 3 may be performed by system 130 running Lattice Diamond software to configure the PLD 100. In some embodiments, the various files and information referenced in FIG. 3 may be stored, for example, in one or more databases and/or other data structures in the memory 134, the machine readable medium 136, and/or other storage.

In operation 310, the system 130 receives a user design that specifies the desired functionality of the PLD 100. For example, the user may interact with the system 130 (e.g., through the user input device 137 and HDL code representing the design) to identify various features of the user design (e.g., high level logic operations, hardware configurations, I/O and/or SERDES operations, and/or other features). In some embodiments, the user design may be provided in a register transfer level (RTL) description (e.g., a gate level description). The system 130 may perform one or more rule checks to confirm that the user design describes a valid configuration of PLD 100. For example, the system 130 may reject invalid configurations and/or request the user to provide new design information as appropriate. In an embodiment, each logic instance (e.g., implemented on a PLD) may receive a respective user design.

In operation 320, the system 130 synthesizes the design to create a netlist (e.g., a synthesized RTL description) identifying an abstract logic implementation of the user design as a plurality of logic components (e.g., also referred to as netlist components). In some embodiments, the netlist may be stored in Electronic Design Interchange Format (EDIF) in a Native Generic Database (NGD) file.

In some embodiments, synthesizing the design into a netlist in operation 320 may involve converting (e.g., translating) the high-level description of logic operations, hardware configurations, and/or other features in the user design into a set of PLD components (e.g., logic blocks 104, logic cells 200, and other components of the PLD 100 configured for logic, arithmetic, or other hardware functions to implement the user design) and their associated interconnections or signals. Depending on embodiments, the converted user design may be represented as a netlist.

In some embodiments, synthesizing the design into a netlist in operation 320 may further involve performing an optimization process on the user design (e.g., the user design converted/translated into a set of PLD components and their associated interconnections or signals) to reduce propagation delays, consumption of PLD resources and routing resources, and/or otherwise optimize the performance of the PLD when configured to implement the user design. Depending on embodiments, the optimization process may be performed on a netlist representing the converted/translated user design. Depending on embodiments, the optimization process may represent the optimized user design in a netlist (e.g., to produce an optimized netlist).

In some embodiments, the optimization process may include optimizing routing connections identified in a user design. For example, the optimization process may include detecting connections with timing errors in the user design, and interchanging and/or adjusting PLD resources implementing the invalid connections and/or other connections to reduce the number of PLD components and/or routing resources used to implement the connections and/or to reduce the propagation delay associated with the connections. In some cases, wiring distances may be determined based on timing.

In operation 330, the system 130 performs a mapping process that identifies components of the PLD 100 that may be used to implement the user design. In this regard, the system 130 may map the optimized netlist (e.g., stored in operation 320 as a result of the optimization process) to various types of components provided by the PLD 100 (e.g., logic blocks 104, logic cells 200, embedded hardware, and/or other portions of the PLD 100) and their associated signals (e.g., in a logical fashion, but without yet specifying placement or routing). In some embodiments, the mapping may be performed on one or more previously-stored NGD files, with the mapping results stored as a physical design file (e.g., also referred to as an NCD file). In some embodiments, the mapping process may be performed as part of the synthesis process in operation 320 to produce a netlist that is mapped to PLD components.

In operation 340, the system 130 performs a placement process to assign the mapped netlist components to particular physical components residing at specific physical locations of the PLD 100 (e.g., assigned to particular logic cells 200, logic blocks 104, clock-related circuitry 108, routing resources 180, and/or other physical components of PLD 100), and thus determine a layout for the PLD 100. In some embodiments, the placement may be performed in memory on data retrieved from one or more previously-stored NCD files, for example, and/or on one or more previously-stored NCD files, with the placement results stored (e.g., in the memory 134 and/or the machine readable medium 136) as another physical design file.

In operation 350, the system 130 performs a routing process to route connections (e.g., using the routing resources 180) among the components of the PLD 100 based on the placement layout determined in operation 340 to realize the physical interconnections among the placed components. In some embodiments, the routing may be performed in memory on data retrieved from one or more previously-stored NCD files, for example, and/or on one or more previously-stored NCD files, with the routing results stored (e.g., in the memory 134 and/or the machine readable medium 136) as another physical design file.

In various embodiments, routing the connections in operation 350 may further involve performing an optimization process on the user design to reduce propagation delays, consumption of PLD resources and/or routing resources, and/or otherwise optimize the performance of the PLD when configured to implement the user design. The optimization process may in some embodiments be performed on a physical design file representing the converted/translated user design, and the optimization process may represent the optimized user design in the physical design file (e.g., to produce an optimized physical design file).

Changes in the routing may be propagated back to prior operations, such as synthesis, mapping, and/or placement, to further optimize various aspects of the user design.

Thus, following operation 350, one or more physical design files may be provided which specify the user design after it has been synthesized (e.g., converted and optimized), mapped, placed, and routed (e.g., further optimized) for the PLD 100 (e.g., by combining the results of the corresponding previous operations). In operation 360, the system 130 generates configuration data for the synthesized, mapped, placed, and routed user design. In various embodiments, such configuration data may be encrypted and/or otherwise secured as part of such generation process. In operation 370, the system 130 configures/programs the PLD 100 with the configuration data (e.g., a configuration) into the PLD 100 over the connection 140. Such configuration may be provided in an encrypted, signed, or unsecured/unauthenticated form dependent on application/requirements.

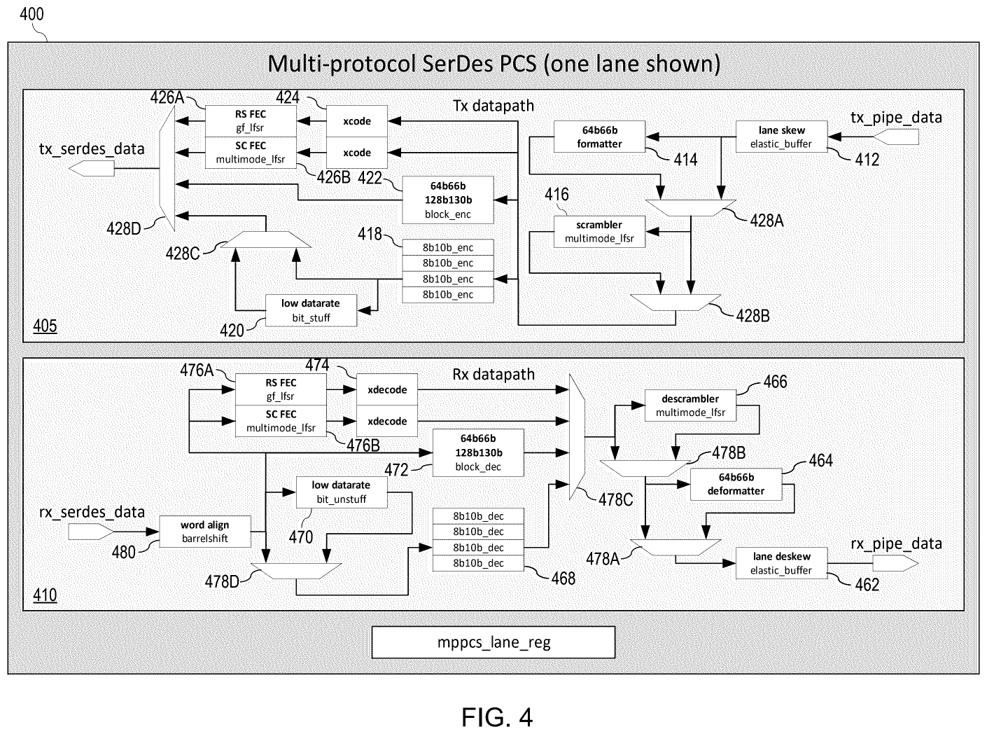

FIG. 4 illustrates an example datapath architecture of a multi-protocol physical coding sublayer (PCS) circuit 400 in accordance with one or more embodiments of the present disclosure. In some embodiments, the datapath architecture is a synchronous datapath architecture (e.g., fully synchronous datapath architecture) having a deterministic latency. The PCS circuit 400 may implement various functionalities (e.g., logic) of a PCS layer defined in different I/O protocols (e.g., different serial I/O protocols). Various functionalities/blocks may be implemented according to the IEEE 802.3 specification. The different protocols may include Ethernet (e.g., 10GBASE-R, 1KBASEX, SGMII, QSGMII, XAUI, and/or others), SLVS-EC, CoaXPress, DisplayPort (e.g., DP/eDP), peripheral component interconnect express (PCIe), and Generic 8B10B. Although a single lane is shown in FIG. 4, the multi-protocol PCS circuit 400 may include multiple lanes in some cases. Each lane may be designed to accommodate a respective set or protocols. For example, a subset of lanes may support Ethernet 10GBASE-R whereas another subset of lanes may support one or more other protocols but not Ethernet 10GBASE-R. In an embodiment, one or more of the PCS blocks 152 of FIG. 1 may be, may include, or may be implemented using the PCS circuit 400.

The PCS circuit 400 includes a transmit datapath 405 and a receive datapath 410. The transmit datapath 405 receives a data signal “tx_pipe_data” and transmits a data signal “tx_serdes_data”. The receive datapath 410 receives a data signal “rx_serdes_data” and transmits a data signal “rx_pipe_data”. In some embodiments, the transmit datapath 405 may receive the data “tx_pipe_data” from a component upstream of the transmit datapath 405 and transmit the data “tx_serdes_data” to a deserializer downstream of the transmit datapath 405, and/or the receive datapath 410 may receive the data “rx_serdes_data” from a serializer upstream of the receive datapath 410 and transmit the data “rx_pipe_data” to a component downstream of the receive datapath 410. In some aspects, the “tx_pipe_data” and the “rx_pipe_data” may include physical interface for PCI express (PIPE) data. In some cases, the component upstream of the transmit datapath 405 may be a programmable logic core and/or a gearbox. In some cases, the component downstream of the receive datapath 410 may be a programmable logic core and/or a gearbox.

For the PCS functionality, the transmit datapath 405 may include an elastic buffer 412, a 64 bit/66 bit (64b66b) formatter 414, a scrambler 416, 8b10b encoders 418, a low data rate block 420, 64b66b and 128b130b encoder 422, transcoder (xcode) blocks 424, Reed Solomon (RS) forward error correction (FEC) block 426A, short cycle (SC) FEC block 426B, and multiplexers 428A-D. The receive datapath 410 includes corresponding blocks. In this regard, the receive datapath 410 may include an elastic buffer 462, a 64b66b deformatter 464, a descrambler 466, 8b10b decoders 468, a low data rate block 470, 64b66b and 128b130b decoder 472, transcoder (xdecode) blocks 474, RS FEC block 476A, SC FEC block 476B, a word align block 480, and multiplexers 478A-D. Various of these PCS blocks may be implemented using hardware and/or software. In some aspects, one or more of these PCS blocks may be implemented according to the IEEE 802.3 specification.

As provided above, the PCS circuit 400 may support various protocols. Support for the various protocols may be facilitated using the multiplexers 428A-D in the transmit datapath 405 and the multiplexers 478A-D in the receive datapath 410. For example, to process a given set of signals according to a desired protocol, the multiplexers 428A-D of the transmit datapath 405 may appropriately route the signals through certain blocks of the transmit datapath 405 associated with the desired protocol while bypassing other blocks not associated with the desired protocol and, similarly, the multiplexers 478A-D of the receive datapath 410 may appropriately route the signals through certain blocks of the receive datapath 405 associated with the desired protocol while bypassing other blocks not associated with the desired protocol. In an aspect, a latency of the PCS circuit 400 may generally include any latency associated with propagation of data (e.g., one or more data words) through the PCS circuit 400 (e.g., from one component of a datapath to another component of the datapath), to a SERDES coupled to the PCS circuit 400, to a programmable logic core coupled to the PCS circuit 400, and/or to any other component coupled to the PCS circuit 400.

As non-limiting examples, the 8b10b encoders 418 and the 8b10b decoders 468 may be used by the PCS circuit 400 to support 8b/10b PCS-based packet protocols. In 8b/10b, the 8 bits may include 8-bit data before 8b/10b encoding by the 8b10b encoders 418 or after 8b/10b decoding by the 8b10b decoders 468. The 10-bit data may include 10-bit direct current (DC)-balanced code before 8b/10b decoding or after 8b/10b encoding. As other non-limiting examples, the 64b66b and 128b130b encoder 422 may be selectively configured to encode 64-bit data into 66-bit data or 128-bit data into 130-bit data dependent on a desired application and similarly for the 64b66b and 128b130b decoder 472. As other non-limiting examples, the low data rate blocks 420 and 470 may be used for bit stuffing and bit unstuffing, respectively. The low data rate blocks 420 and 470 may be needed to allow for a low data rate when a clock cannot be slowed down. In some such cases, the same data may be sent repeatedly.

In some embodiments, the elastic buffers 412 and 462 may be used for clock phase difference determination and elimination and uncertain latency elimination. In some aspects, the elastic buffers 412 and 462 may perform clock compensation by inserting or deleting bytes at the position where a skip pattern is detected, without causing loss of packet data. The elastic buffers 412 and 462 may be implemented to buffer incoming data and transfer the data. In some embodiments, as further described herein, each of the elastic buffers 412 and 462 may have control ports and observation ports whose data may be monitored (e.g., by a logic circuit communicatively coupled to these ports) for latency purposes. Such latency monitoring may allow a phase between the read and write clocks of each of the elastic buffers 412 and 462 to be determined, thus supporting a synchronous datapath architecture having a deterministic latency.

The scrambler 416 may scramble payload data (e.g., 64-bit block payload data) using a polynomial, such as one specified by the IEEE 802.3 specification in some cases. The descrambler 466 descrambles payload data (e.g., 64-bit block payload data). Header bits are not part of the scrambling by the scrambler 416 or descrambling by the descrambler 466. The word align block 480 may receive parallel data from the deserializer and restore word boundaries of an upstream transmitter that are lost upon deserialization. In some cases, to facilitate alignment, transmitters may send a recognized sequence (e.g., a comma) periodically and a receiver may search for the comma in incoming data and align accordingly.

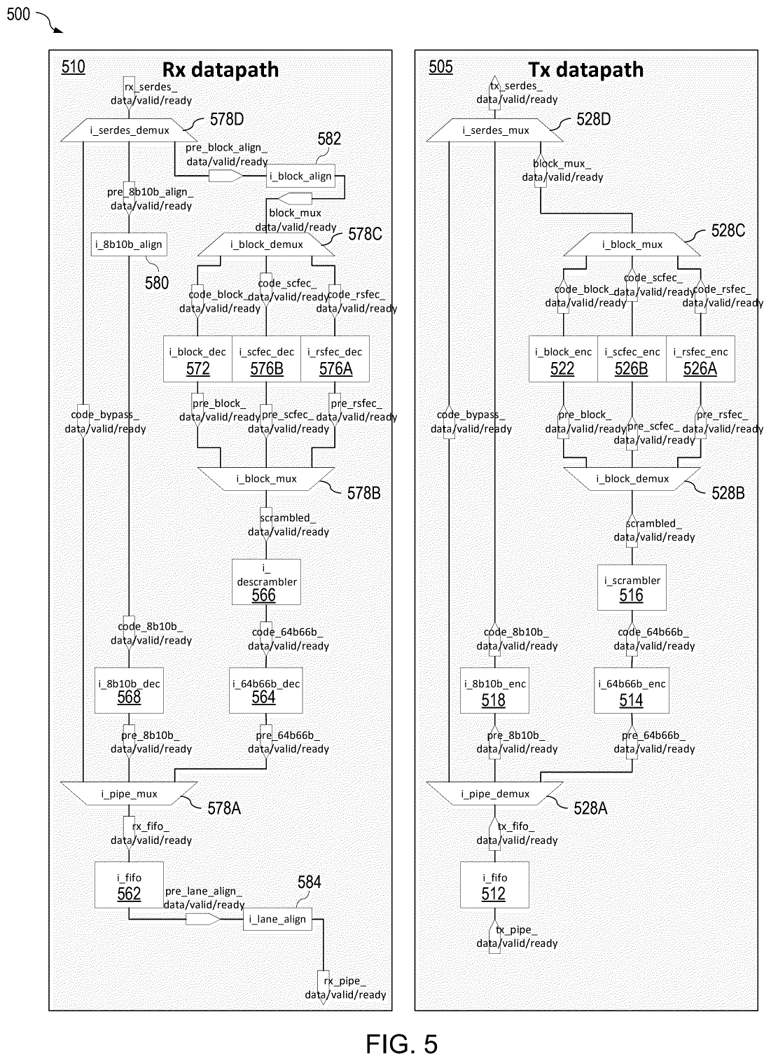

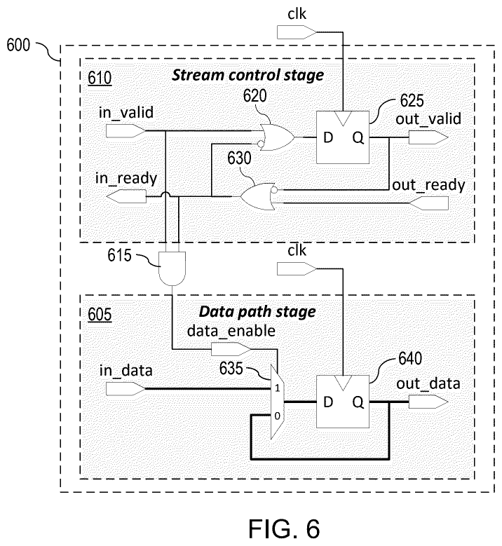

FIG. 5 illustrates an example flow 500 associated with a PCS circuit having a transmit datapath 505, a receive datapath 510, and associated data and dataflow control signals in accordance with one or more embodiments of the present disclosure. In an embodiment, the flow 500 may include similar components as and/or may be used to implement at least in part the PCS circuit 400 of FIG. 4. The description of FIG. 4 generally applies to FIG. 5, and vice versa, with differences between FIG. 4 and FIG. 5 and other description provided herein. In an embodiment, valid and ready signals of the transmit datapath 505 and the receive datapath 510 facilitate dataflow and thus may be collectively referred to as dataflow control signals or simply control signals. In some cases, the ready and valid signals may be referred to as and/or considered a handshake. In this regard, the valid and ready signals may be used to establish a handshake between different stages of the transmit datapath 505 or the receive datapath 510. In some aspects, the transmit datapath 505 and the receive datapath 510 may be implemented with various components (e.g., multiplexers, demultiplexers, flip-flops, combinatorial logic gates, etc.) not explicitly shown in FIG. 5 for facilitating flow of the data and the dataflow control signals. For example, select signals to the multiplexers or demultiplexers may be based on outputs of combinatorial logic gates whose inputs are valid and ready signals, as further described herein with respect, for example, to FIG. 6.

Turning first to the transmit datapath 505, an elastic buffer 512 may be associated with a data signal “tx_pipe_data”, a valid signal “tx_pipe_valid”, and a ready signal “tx_pipe_ready. In this regard, a signal set denoted as “tx_pipe_data/valid/ready” may be a shorthand representation of the data signal “tx_pipe_data”, the valid signal “tx_pipe_valid”, and the ready signal “tx_pipe_ready”. Other signal sets in FIG. 5 may be represented using a similar shorthand. Furthermore, it is noted that “tx_pipe_data”, “tx_pipe_valid”, “tx_pipe_ready”, and others in FIG. 5 and other figures, may represent data paths/busses over which the corresponding signals are transferred over and/or received from, registers these signals may be stored (if such storage is needed), and so forth, in addition to representing the signals themselves.

The data signal “tx_pipe_data” may be from a component upstream of the transmit datapath 505. In some cases, the component may be a programmable logic core (e.g., also referred to as a programmable logic fabric or fabric and abbreviated as PLC) and/or a gearbox. In FIG. 5, the elastic buffer 512 is implemented as a first-in-first-out (FIFO) buffer. The valid signal “tx_pipe_valid” may be transferred from the upstream component to the elastic buffer 512 to indicate to the elastic buffer 512 that the upstream component has valid data (e.g., “tx_pipe_data”) to transfer to the elastic buffer 512. The ready signal “tx_pipe_ready” may be transferred from the elastic buffer 512 to the upstream component to indicate to the upstream component that the elastic buffer 512 can receive data (e.g., the elastic buffer 512 has available storage).

In some aspects, the upstream component may transfer the data signal “tx_pipe_data” to the elastic buffer 512 only when both the valid signal “tx_pipe_valid” and the ready signal “tx_pipe_ready” are asserted (e.g., logic high or logic ‘1’) during the same clock cycle. The valid signal “tx_pipe_valid” and the ready signal “tx_pipe_ready” may define/implement a valid/ready handshake between the upstream component and the elastic buffer 512. Such description of the valid/ready handshake and associated data transfer/receipt generally applies to any stage (e.g., any transmitter/receiver-pair in which one component is a transmitter of data and another component is a receiver of the data) in FIG. 5. In an embodiment, for explanatory purposes, an asserted signal may be a logic high (e.g., “1”). However, in general, an asserted signal may be a logic high or a logic low (e.g., “0”) depending on implementation. For example, when the ready signal “tx_pipe_ready” and the valid signal “tx_pipe_valid” start being asserted during the same clock cycle, the data signal “tx_pipe_data” may be transferred during a next clock signal. In some cases, such as when a transmitter and a receiver are continuously transmitting and receiving, the ready and valid signals may remain asserted continuously to allow the data to flow continuously (e.g., until one or both of the ready and valid signals is deasserted). A receiver may control the ready signal to limit data flow to the receiver, whereas a transmitter may control the valid signal and the data signal to limit data sent out by the transmitter.

The elastic buffer 512 may transmit a data signal “tx_fifo_data” and a valid signal “tx_fifo_data” and receive a ready signal “tx_fifo_ready”. Based on a select signal (not shown), a demultiplexer 528A may direct the data signal “tx_fifo_data” from the elastic buffer 512 to a multiplexer 528D (e.g., a route that bypasses coding such as 8b10b coding, 64b66b coding, etc.), an 8b10b encoder 518, or a 64b66b encoder 514. For example, when the 8b10b encoder 518 is to receive the data signal “tx_fifo_data”, which is relabeled as “pre_8b10b_data” along the transmit datapath 505, the 8b10b encoder 518 may receive a valid signal “pre_8b10b_valid” from an upstream component (e.g., the elastic buffer 512 in this stage) indicating the upstream component has data to send to the 8b10b encoder 518 and the 8b10b encoder 518 may transmit a ready signal “pre_8b10b_ready” to the upstream component to indicate the 8b10b encoder 518 is ready to receive data. Similar data flow and valid/ready handshakes may be performed as data flows from the 8b10b encoder 518 to the multiplexer 528D.

When the 64b66b encoder 514 is to receive the data signal “tx_fifo_data”, which is relabeled as “pre_64b66b_data”, the 64b66b encoder 514 may receive a valid signal “pre_64b66b_valid” from an upstream component (e.g., the elastic buffer 512 in this stage) indicating the upstream component has data to send to the 64b66b encoder 514 and the 64b66b encoder 514 may transmit a ready signal “pre_64b66b_ready” to the upstream component to indicate the 64b66b encoder 514 is ready to receive data. Similar data flow and valid/ready handshakes may be performed as data flows from the 64b66b encoder 514 to a scrambler 516 and then to a demultiplexer 528B; a block encoder 522, an SC FEC encoder 526B, and/or an RS FEC encoder 526A; a multiplexer 528C; and the multiplexer 528D.

The transmit datapath 505 may transmit a valid signal “tx_serdes_valid” to a downstream component (e.g., a serializer of a SERDES circuit) to indicate the transmit datapath 505 has a data signal “tx_serdes_data” to transfer to the downstream component. The downstream component may transmit a ready signal “tx_serdes_ready” to the transmit datapath 505 when the downstream component is ready to receive data from the transmit datapath 505. The transmit datapath 505 may transmit the data signal “tx_serdes_data” to the downstream component when both the ready signal “tx_serdes_ready” and the valid signal “tx_serdes_valid” are asserted.

The receive datapath 510 has a similar flow as the transmit datapath 505. The receive datapath 510 may receive a data signal “rx_serdes_data” and a valid signal “rx_serdes_valid” from an upstream component (e.g., a deserializer of a SERDES circuit) and may transmit a ready signal “rx_serdes_ready” to the upstream component. The data signal “rx_serdes_data” may be transferred by the upstream component to the receive datapath 510 when both the valid signal “rx_serdes_valid” and the ready signal “rx_serdes_ready” are asserted (e.g., logic high or logic ‘1’).

Based on a select signal (not shown), a demultiplexer 578D may direct the data signal “rx_serdes_data” to a multiplexer 578A (e.g., a route that bypasses coding such as 8b10b coding, 64b66b coding etc.), an aligner block 580 associated with 8b/10b coding, and an aligner block 582 associated with 128b/130b and/or 64b/66b coding. For example, when the aligner block 580 is to receive the data signal “rx_serdes_data”, which is relabeled as “pre_8b10b align_data”, the aligner block 580 may receive a valid signal “pre_8b10b_align_valid” from an upstream component indicating the upstream component has data to send to the aligner block 580 and the aligner block 580 may transmit a ready signal “pre_8b10b_align_ready” to the upstream component to indicate the aligner block 580 is ready to receive data. Similar data flow and valid/ready handshakes may be performed as data flows from the aligner block 580 to an 8b10b decoder 568 and the multiplexer 578A.

When the aligner block 582 is to receive the data signal “rx_serdes_data”, which is relabeled as “pre_block_align_data”, the aligner block 582 may receive a valid signal “pre_block_align_valid” from an upstream component indicating the upstream component has data to send to the aligner block 582 and the aligner block 582 may transmit a ready signal “pre_block_align_ready” to the upstream component to indicate the aligner block 582 is ready to receive data. Similar data flow and valid/ready handshakes may be performed as data flows from the aligner block 582 to a demultiplexer 578C; a block decoder 572, an SC FEC decoder 576B, and/or an RS FEC decoder 576A; a multiplexer 578B; a descrambler 566; a 64b66b decoder 564; and the multiplexer 578A.

At the multiplexer 578A, data flow and valid/ready handshakes may be performed as data flows to an elastic buffer 562 and a lane aligner block 584. The lane aligner block 584 may transmit a data signal “rx_pipe_data” and a valid signal “rx_pipe_valid” to a downstream component (e.g., a programmable logic core and/or a gearbox) and receive a ready signal “rx_pipe_ready” from the downstream component. The lane aligner block 584 may transmit the data signal to the downstream component when both the valid signal “rx_pipe_valid” and the ready signal “rx_pipe_ready” are asserted.

FIG. 6 illustrates a component 600 of the datapath architecture of FIGS. 4 and 5 in accordance with one or more embodiments of the present disclosure. The component 600 may generally be any component used to temporarily store/buffer data, with flow of data being controlled using dataflow control signals (e.g., valid and ready signals). In an aspect, FIG. 6 may be considered as providing a flow (e.g., an atomic flow) associated with operation of the component 600. The component 600 includes a data path stage 605 for driving data at an input side/port to an output side/port and a stream control stage 610 for controlling flow of data in the data path stage 605. An AND gate 615 connects the data path stage 605 to the stream control stage 610. In some cases, the AND gate 615 may be considered as being part of the data path stage 605, part of the stream control stage 610, or an interface component between the data path stage 605 and the stream control stage 610. The data at the input side/port is denoted as “in_data” and data at the output side/port is denoted as “out_data”. Although FIG. 6 illustrates a combination of components (e.g., multiplexers, flip-flops, combinatorial logic gates, etc.), this combination of components provides one example representation and/or implementation of the component 600 and the component 600 may be represented and/or implemented using a different combination of components. Implementation of the component 600 may be based on hardware and/or software.

The stream control signal 610 is associated with input side and output side valid signals and ready signals. Each data input signal “in_data” (e.g., each data word) is associated with a corresponding valid signal “in_valid” and a corresponding ready signal “in_ready”. The valid signal “in_valid” at the input side may be an indication/message of a validity of the data input signal “in_data” provided by an upstream component that is transmitting to the component 600 the data for processing by the component 600. The ready signal “in_ready” at the input side may be an indication/message provided by the component 600 to the upstream component that the component 600 is ready to accept (e.g., has storage available) the data signal “in_data” from the upstream component. The valid signal “out_valid” at the output side may be an indication/message provided by the component 600 to a downstream component that the component 600 has data “out_data” to transfer to the downstream component. The ready signal “out_ready” at the output side may be an indication/message provided by the downstream component to the component 600 that the downstream component is ready to accept data from the component 600.

An OR gate 620 receives at its inputs the valid signal “in_valid” and an inverted version of the ready signal “in_ready”. An output of the OR gate 620 is a logic low (e.g., logic ‘0’) when the valid signal “in_valid” is not asserted (e.g., data is not valid) and the ready signal “in_ready” is asserted (e.g., receiver is ready to receive data). Otherwise, the output of the OR gate 620 is a logic high. The output of the OR gate 620 is provided for storage in a storage element 625 connected to the OR gate 620. In an aspect, as shown in FIG. 6, the storage element 625 may be a D-type flip-flop (DFF) (e.g., also referred to as a D flip flop, delay flip flop, or data flip flop) operated according to a clock clk. The storage element 625 may provide the valid signal “out_valid” on the output side.

An OR gate 630 receives at its inputs the ready signal “out_ready” and an inverted version of the valid signal “out_valid”. An output of the OR gate 630 is a logic low when the valid signal “out_valid” (e.g., data is valid) is asserted and the ready signal “out_ready” is not asserted (e.g., receiver is not ready to receive data). Otherwise, the output of the OR gate 630 is a logic high. It is noted that a flow of the valid signals (e.g., from “in_valid” to “out_valid”) is in the same direction as the data signals (e.g., from “in_data” to “out_data”), whereas a flow of the ready signals (e.g., from “out_ready” to “in_ready”) is in the opposite direction as the data signals.

The AND gate 615 receives at its inputs the valid signal “in_valid” and the ready signal “in_ready” and generates a data enable signal “data_enable” based on its inputs. The data enable signal “data_enable” is asserted (e.g., logic high) when, and only when, the valid signal “in_valid” (e.g., data is valid) and the ready signal “in_ready” (e.g., data is ready to be received) are asserted. Otherwise, the data enable signal “data_enable” is not asserted.

A multiplexer 635 receives at its first input (e.g., its logic high input or “1” input) the data signal “in_data” and its second input (e.g., its logic low input or “0” input) the data signal “out_data”. The multiplexer 635 selects/provides at its output the input signal at its first input (i.e., the data signal “in_data”) when the “data_enable” signal is asserted and selects/provides at its output the input signal at its second input (i.e., the data signal “out_data”) when the “data_enable” signal is not asserted. The output of multiplexer 635 is provided for storage in a storage element 640 connected to the multiplexer 635. In an aspect, as shown in FIG. 6, similar to the storage element 625, the storage element 640 may be a D-type flip-flop operated according to the clock clk. The storage element 640 may provide the data signal “out_data” on the output side.

If the “data_enable” signal is asserted, the data signal “in_data” at the input side is directed/routed to the output side (e.g., via the multiplexer 635 and the storage element 640) as the data signal “out_data” at the output side. If the “data_enable” is deasserted, the data signal “out_data” is directed/routed back to the storage element 640 and back to the multiplexer 635. In this regard, the storage element 640 does not change in value and, as such, data flow is stalled for a clock cycle.

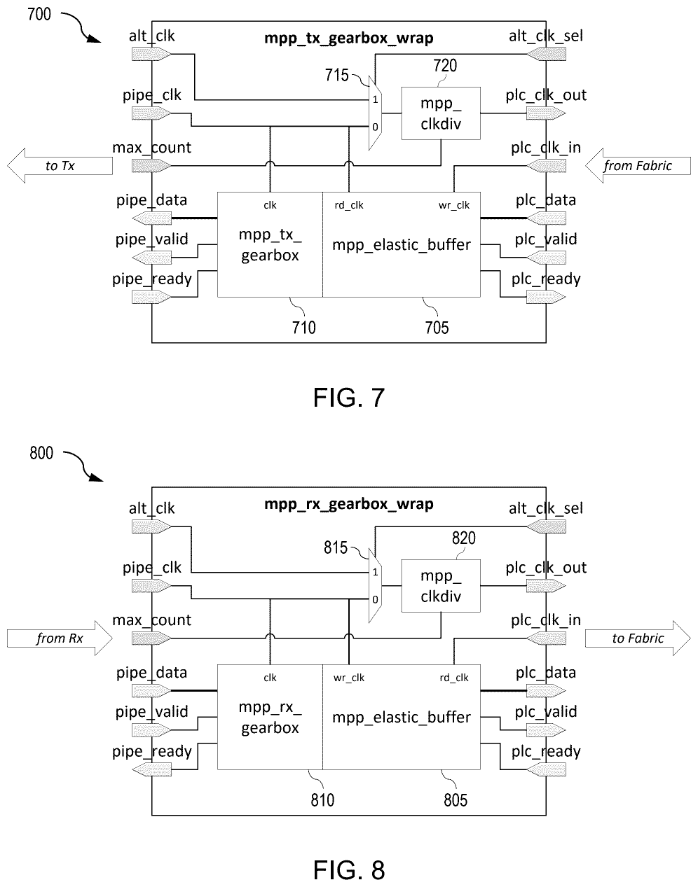

FIG. 7 illustrates a block diagram of a transmit-side component/circuit 700 for providing gearbox functionality in accordance with one or more embodiments of the present disclosure. The transmit-side component 700 includes a transmit-side elastic buffer 705, a transmit-side gearbox 710, a multiplexer 715, and a clock divider 720. The transmit-side circuit 700 receives signals from one or more upstream components and transmits signals to one or more downstream component. The transmit-side component 700 may provide and/or may couple to initial components of a PCS transmit datapath (e.g., the transmit datapath 405 of FIG. 4). In an embodiment, the upstream component(s) may include a programmable logic core (e.g., also referred to as a programmable logic fabric or simply fabric) that interfaces with a PCS via the transmit-side component 700 of the PCS. The downstream component(s) may include a component of a PCS transmit datapath such as the elastic buffer 412 of FIG. 4, the elastic buffer 512 of FIG. 5, and/or other components. In this regard, in an embodiment, the transmit-side component 700 may couple to the elastic buffer 412 of FIG. 4 and/or the elastic buffer 512 of FIG. 5. In an embodiment, the transmit-side component 700 may be considered part of a PCS circuit (e.g., the PCS circuit 400 of FIG. 4 or the PCS circuit of FIG. 5) or a separate component that is coupled to the PCS circuit.

The transmit-side component 700 may receive, from the programmable logic core, a data signal “plc_data” and a valid signal “plc_valid”. In some cases, the transmit-side component 700 may receive a clock select signal “alt_clk_sel” and/or a clock signal “plc_clk_in” from the programmable logic core and/or other upstream component(s). The transmit-side component 700 may receive, from one or more downstream components in the transmit datapath, a clock signal “pipe_clk”, a clock signal “alt_clk”, a signal “max_count”, and a ready signal “pipe_ready”. The transmit-side component 700 may provide, to the programmable logic core, a ready signal “plc_ready”, and may provide, to a downstream component in the transmit datapath, a data signal “pipe_data” and a valid signal “pipe_valid”. In some cases, the transmit-side component 700 may provide a clock signal “plc_clk_out” to the programmable logic core and/or other upstream component. In some cases, the signal “max_count” may be a design parameter of the transmit-side gearbox 710, as further described herein.

The elastic buffer 705 receives the clock signal “plc_clk_in” (e.g., from the programmable logic core) and uses the clock signal “plc_clk_in” as its write domain clock “wr_clk” and receives the clock signal “pipe_clk” from a downstream component and uses the clock signal “pipe_clk” as its read domain clock “rd_clk”. In some aspects, the “wk_clk” and “rd_clk” are isochronous. The elastic buffer 705 receives the data signal “plc_data” and the valid signal “plc_valid” from the programmable logic core. The data signal “plc_data” may include data for storage and subsequent transfer by the elastic buffer 705 to the gearbox 710 for processing by the gearbox 710. In some aspects, the elastic buffer 705 may be a FIFO buffer. The valid signal “plc_valid” provides an indication/message, from the programmable logic core to the elastic buffer 705, of a validity of the data input signal “plc_data” that the elastic buffer 705 receives from the programmable logic core. The ready signal “plc_read” generated by the elastic buffer 705 provides an indication/message, from the elastic buffer 705 to the programmable logic core, that the elastic buffer 705 is ready to accept data (e.g., the elastic buffer 705 has storage available for additional data). The programmable logic core may provide the data signal “plc_data” to the elastic buffer 705 for storage when the valid signal “plc_valid” and the ready signal “plc_ready” are both asserted (e.g., both logic high).

The gearbox 710 receives the clock signal “pipe_clk” from a downstream component. In this regard, the gearbox 710 operates according to only a single clock. The elastic buffer 705 transfers the data signal “plc_data” received from the programmable logic core to the gearbox 710. The gearbox 710 processes the data signal “plc_data” to generate the data signal “pipe_data”. The valid signal “pipe_valid” generated by the gearbox 710 provides an indication/message, from the gearbox 710 to a downstream component (e.g., the elastic buffer 412 of FIG. 4) in the transmit datapath, of a validity of the data input signal “pipe_data” that is to be provided to the downstream component by the gearbox 710. The ready signal “plc_ready” provides an indication/message, from the downstream component to the gearbox 710, that the downstream component is ready to accept data (e.g., the “pipe_data”) from the gearbox 710. The gearbox 710 may provide the data signal “pipe_data” to the downstream component when the valid signal “pipe_valid” and the ready signal “pipe_ready” are both asserted (e.g., both logic high). Dependent on application and/or protocols to be accommodated, the gearbox 710 may slow down and widen data as the data leaves the gearbox 710 or speed up and narrow the data as the data leaves the gearbox 710. The degree to which the data is widened or narrowed may be represented by a gearbox ratio N.

The multiplexer 715 receives the “alt_clk_sel” signal at its select input from an upstream component (e.g., the programmable logic core and/or other upstream component), the “pipe_clk” signal at its ‘0’ input from a downstream component, and the “alt_clk” signal at its ‘1’ input from a downstream component. The “alt_clk_sel” signal is a select signal used to indicate whether or not to use the “alt_clk” signal. In this regard, the multiplexer 715 provides the “pipe_clk” signal at its output when the “alt_clk_sel” signal is a logic low and the “alt_clk” signal at its output when the “alt_clk_sel” signal is a logic high.

The clock divider 720 receives “max_count” and the output of the multiplexer 715. The clock divider 720 generates the clock signal “plc_clk_out” based on “max_count” and the output of the multiplexer 715 and provides the clock signal “plc_clk_out” to the programmable logic core and/or other upstream component. In some cases, the different clocks “alt_clk” and “pipe_clk” may allow the PCS and the programmable logic core to be compatible with multiple protocols, with a state (e.g., 0 or 1) of the “alt_clk_sel” signal indicating whether the clock divider 720 generates the “plc_clk_out” signal using the “pipe_clk” signal or the “alt_clk” signal. Although in FIG. 7 the transmit-side component 700 may receive two clock signals that can be selectively processed by the clock divider 720, in other cases a transmit-side component may receive only one clock signal or more than two clock signals that can be selectively processed by a clock divider to generate a “plc_clk_out” signal.

FIG. 8 illustrates a block diagram of a receive-side component/circuit 800 for providing gearbox functionality in accordance with one or more embodiments of the present disclosure. The receive-side component 800 includes a receive-side elastic buffer 805, a receive-side gearbox 810, a multiplexer 815, and a clock divider 820. The receive-side circuit 800 receives signals from one or more upstream components in a receive datapath (e.g., the receive datapath 410) and transmits signals to one or more downstream components. The receive-side component 800 may interface with a programmable logic core. In an embodiment, the downstream component may be a programmable logic core that interfaces with a PCS via the receive-side component 800 of the PCS, and the upstream component may include a component of the receive datapath such as the elastic buffer 462 of FIG. 4, the elastic buffer 562 of FIG. 5, and/or other components. In this regard, in an embodiment, the receive-side component 800 may couple to the elastic buffer 412 of FIG. 4 and/or the elastic buffer 512 of FIG. 5. In an embodiment, the receive-side component 800 may be considered part of a PCS circuit (e.g., the PCS circuit 400 of FIG. 4 or the PCS circuit of FIG. 5) or a separate component that is coupled to the PCS circuit. The receive-side component 800 provides a receiver-side counterpart to the transmit-side component 700 of FIG. 7 and, as such, the description of the transmit-side component 700 of FIG. 7 generally applies and aligns with the receive-side component 800 of FIG. 8.

The receive-side component 800 receives, from the programmable logic core, a ready signal “plc_ready”. In some cases, the receive-side component 800 may receive a clock select signal “alt_clk_sel” and/or a clock signal “plc_clk_in” from the programmable logic core and/or other downstream component(s). The receive-side component 800 receives, from one or more upstream components in the receive datapath, a clock signal “pipe_clk”, a clock signal “alt_clk”, a signal “max_count”, a data signal “pipe_data”, and a valid signal “pipe_valid”. The receive-side component 800 may provide, to the programmable logic core, a clock signal “plc_clk_out”, a data signal “plc_data”, and a valid signal “plc_valid”, and provides, to an upstream component in the receive datapath, a ready signal “pipe_ready”. In some cases, the signal “max_count” may be a design parameter of the receive-side gearbox 810, as further described herein.

The gearbox 810 receives the clock signal “pipe_clk” from an upstream component. In this regard, the gearbox 810 operates according to only a single clock. The gearbox 810 receives the data “pipe_data” and the valid signal “pipe_valid” from an upstream component (e.g., the elastic buffer 462). The gearbox 810 transmits the ready signal “pipe_ready” to the upstream component (e.g., the elastic buffer 462). The gearbox 810 may receive the data “pipe_data” when the valid signal “pipe_valid” and the ready signal “pipe_ready” are both asserted. The gearbox 810 may process the data signal “pipe_data” and transfer the processed data downstream to the elastic buffer 805. Dependent on application and/or protocols to be accommodated, the gearbox 810 may slow down and widen data as the data leaves the gearbox 810 or speed up and narrow the data as the data leaves the gearbox 810.

The elastic buffer 805 receives the clock signal “plc_clk_in” (e.g., from the programmable logic core) and uses the clock signal “plc_clk_in” as its read domain clock “rd_clk” and receives the clock signal “pipe_clk” from an upstream component and uses the clock signal “pipe_clk” as its write domain clock “wr_clk”. The elastic buffer 805 receives data from the gearbox 810 and receives the ready signal “plc_ready” from the programmable logic core. The data signal “plc_data” may include data previously stored by the elastic buffer 805 and transferred/read out from the elastic buffer 805 to the programmable logic core. In some aspects, the elastic buffer 805 may be a FIFO buffer. The ready signal “plc_ready” provides an indication/message, from the programmable logic core, that the programmable logic core is ready to accept data from the elastic buffer 805. The valid signal “plc_valid” generated by the elastic buffer 805 provides an indication/message, from the elastic buffer 805 to the programmable logic core, of a validity of the data signal “plc_data” that the elastic buffer 805 transfers or is to transfer to the programmable logic core. The elastic buffer 805 may provide the data signal “plc_data” to the programmable logic core when the valid signal “plc_valid” and the ready signal “plc_ready” are both asserted (e.g., both logic high). In some cases, for the receive-side component 800, a SERDES-facing clock is recovered and the PIPE-facing clock is isochronous to the transmit clock.

The multiplexer 815 receives the “alt_clk_sel” signal at its select input from the programmable logic core and/or other downstream component, the “pipe_clk” signal at its ‘0’ input from an upstream component in the receive datapath, and the “alt_clk” signal at its ‘1’ input from an upstream component in the receive datapath. The “alt_clk_sel” signal is a select signal used to indicate whether or not to use the “alt_clk” signal. In this regard, the multiplexer 815 provides the “pipe_clk” signal at its output when the “alt_clk_sel” signal is a logic low and the “alt_clk” signal at its output when the “alt_clk_sel” signal is a logic high.

The clock divider 820 receives “max_count” and the output of the multiplexer 815. The clock divider 820 generates the clock signal “plc_clk_out” based on “max_count” and the output of the multiplexer 815 and provides the clock signal “plc_clk_out” to the programmable logic core and/or other downstream component(s). In some cases, the different clocks “alt_clk” and “pipe_clk” may allow the PCS and the programmable logic core to be compatible with multiple protocols, with a state (e.g., 0 or 1) of the “alt_clk_sel” signal indicating whether the clock divider 820 generates the “plc_clk_out” signal using the “pipe_clk” signal or the “alt_clk” signal. Although in FIG. 8 the receive-side component 800 may receive two clock signals that can be selectively processed by the clock divider 820, in other cases a receive-side component may receive only one clock signal or more than two clock signals that can be selectively processed by a clock divider to generate a “plc_clk_out” signal.

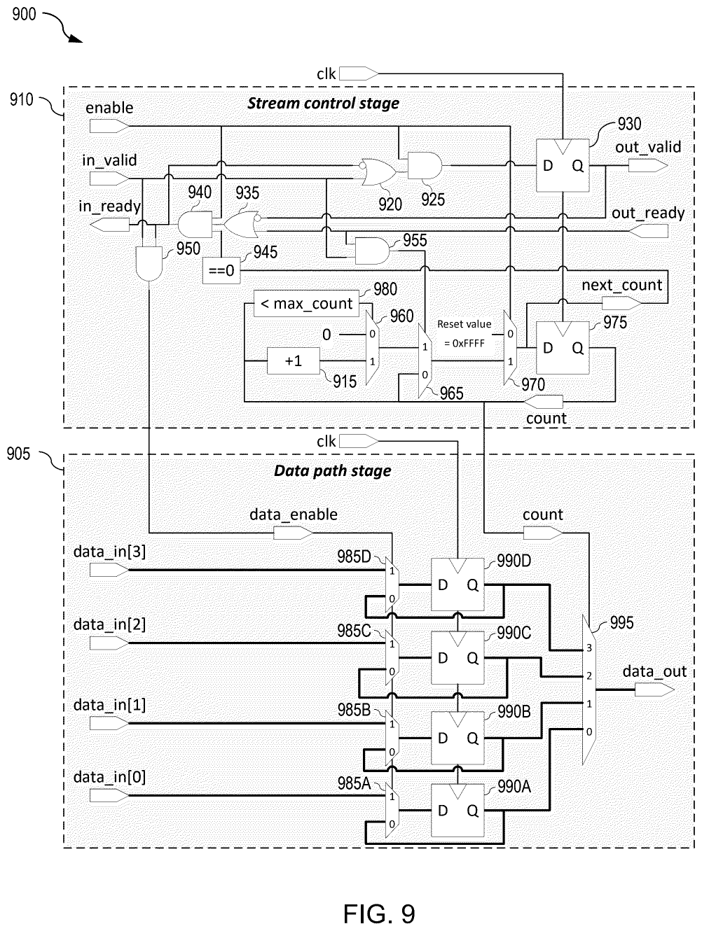

FIG. 9 illustrates a transmit gearbox 900 in accordance with one or more embodiments of the present disclosure. In an aspect, FIG. 9 may be considered as providing a flow (e.g., an atomic flow) associated with operation of the transmit gearbox 900. In some embodiments, such flow may be associated with operation of the transmit gearbox 710 of FIG. 7. The transmit gearbox 900 includes a data path stage 905 for driving data at an input side/port to an output side/port and a stream control stage 910 for controlling flow of data in the data path stage 905. The data at the input side/port is denoted as “data_in [0]” through “data_in [3]” and data at the output side/port is denoted as “data_out”. Although FIG. 9 illustrates a combination of components (e.g., multiplexers, flip-flops, combinatorial logic gates, etc.), this combination of components provides one example representation and/or implementation of the transmit gearbox 900 and the transmit gearbox 900 may be represented and/or implemented using a different combination of components. Implementation of the transmit gearbox 900 may be based on hardware and/or software. The data path stage 905 and the stream control stage 910 have similarities with the corresponding stages the component 600 of FIG. 6 and thus the description related to the component 600 generally applies to the transmit gearbox 900.

The stream control stage 910 is associated with input side and output side valid signals and ready signals. Each set of data signals (e.g., “data_in [0]” through “data_in [3]”) is associated with a corresponding valid signal “in_valid” and a corresponding ready signal “in_ready”. Counter signals, denoted as “count” and “next_count”, and a maximum count signal, denoted “max_count”, control data passing from data signals “data_in [0]” through “data_in [3]” on the input side to data signal “data_out” on the output side. In this regard, the transmit gearbox 900 of FIG. 9 shows a 4-to-1 gearbox, in which, for the data path stage 905, the “max_count”=3 indicates a maximum value that can be assumed by “count” and “next_count”. With the “max_count”=3, each of the counter signals “count” and “next_count” cycles through (e.g., cycles periodically through) values 0, 1, 2, 3 (i.e., “max_count”) and then back to 0, 1, 2, 3, and so forth to direct “data_in [0]” through “data_in [3]” one at a time (e.g., through time-multiplexing) to “data_out”, as further discussed herein. Cycling of the counter signals “count” and “next_count” may be by incrementing at a block 915. Resetting of the counter signals “count” and “next_count” to 0 may be by a block 980 and a multiplexer 960. It is noted that a 4-to-1 gearbox may be configured to operate as a 3-to-1 gearbox, 2-to-1 gearbox, or a 1-to-1 gearbox by setting the “max_count” to 2, 1, or 0, respectively. For example, in the 3-to-1 case, the counter signals “count” and “next_count” cycle through three values: 0, 1, and 2.

An OR gate 920 receives at its inputs the valid signal “in_valid” and an inverted version of the ready signal “in_ready”. An output of the OR gate 920 is a logic low when the valid signal “in_valid” is not asserted (e.g., data is not valid) and the ready signal “in_ready” is asserted (e.g., receiver is ready to receive data). Otherwise, the output of the OR gate 920 is a logic high.

An AND gate 925 receives as its input the output of the OR gate 920 and an enable signal “enable” (e.g., signal to enable or disable functionality of the transmit gearbox 900). An output of the AND gate 925 is a logic high when the output of the OR gate 920 is a logic high and the enable signal “enable” is asserted (e.g., logic high). Otherwise, the output of the AND gate 925 is a logic low. The output of the AND gate 925 is provided for storage in a storage element 930 connected to the AND gate 925. In an aspect, as shown in FIG. 9, the storage element 930 may be a D-type flip-flop operated according to a clock clk. The storage element 930 may provide the valid signal “out_valid” on the output side.

An OR gate 935 receives at its inputs the ready signal “out_ready” and an inverted version of the valid signal “out_valid”. An output of the OR gate 935 is a logic low when the valid signal “out_valid” (e.g., data is valid) is asserted and/or the ready signal “out_ready” is not asserted (e.g., receiver is not ready to receive data). Otherwise, the output of the OR gate 935 is a logic high.

An AND gate 940 receives as its inputs “enable”, the output of the OR gate 935, and an output of a comparator 945 that generates a logic high output when “next_count” is equal to zero and a logic low output otherwise. An output of the AND gate 940 is a logic high when “enable” is a logic high, the output of the OR gate 935 is a logic high, and the output of the comparator 945 is a logic high (e.g., “next_count” is equal to zero). Otherwise, the output of the AND gate 940 is a logic low. The output of the AND gate 940 may provide the ready signal “in_ready”.

An AND gate 950 receives at its inputs the valid signal “in_valid” and the ready signal “in_ready” and generates a data enable signal “data_enable” based on its inputs. The data enable signal “data_enable” is asserted (e.g., logic high) when, and only when, the valid signal “in_valid” (e.g., data is valid) and the ready signal “in_ready” (e.g., data is ready to be received) are asserted. Otherwise, the data enable signal “data_enable” is not asserted.

An AND gate 955 receives at its inputs the ready signal “out_ready” and the valid signal “in_valid”. An output of the AND gate 955 is a logic high when “out_ready” and “in_valid” are logic high.

The counter signals “next_count” and “count” are controlled using multiplexers 960, 965, and 970. The multiplexer 960 receives at its first input a 0 and its second input an incremented value of “count” (i.e., “count”+1). The multiplexer 960 selects/provides at its output the input signal at its first input (i.e., 0) when the output of a comparator 990 is a logic low (e.g., “count” is greater than or equal to “max_count”, although in FIG. 9 “count” can have a value of at most equal to “max_count”) and selects/provides at its output the input signal at its second input when the comparator 980 is a logic high (e.g., “count” is less than “max_count”).

The multiplexer 965 receives at its first input “count” and at its second input the output of the multiplexer 960. The multiplexer 965 selects/provides at its output the input signal at its first input (i.e., “count”) when the output of the AND gate 955 is a logic low and selects/provides at its output the input signal at its second input when the output of the AND gate 955 is a logic high.

The multiplexer 970 receives at its first input a reset value and at its second input the output of the multiplexer 965. The multiplexer 970 selects/provides at its output the input signal at its first input when “enable” is not asserted (e.g., logic low) and selects/provides at its output the input signal at its second input when “enable” is asserted (e.g., logic high). The output of the multiplexer 970 may provide the signal “next_count”. The output of multiplexer 970 is provided for storage in a storage element 975 connected to the multiplexer 970. In an aspect, as shown in FIG. 9, similar to the storage element 930, the storage element 975 may be a D-type flip-flop operated according to the clock clk. The storage element 975 receives “next_count” as input, stores “next_count”, and provides “next count” as “count” (e.g., with timing provided according to the clock signal clk). As such, the multiplexers 960, 965, and 970 collectively cause “count” and “next_count” to cycle through values 0, 1, 2, 3 (i.e., “max_count”), 0, 1, 2, 3, and so forth and cause “count” and “next_count” to be reset (e.g., set to a reset value such as 0xFFFF in FIG. 9) when “enable” is not asserted.

The data path stage 905 includes multiplexers 985A through 985D, storage elements 990A through 990D, and a multiplexer 995. In an aspect, each of the storage elements 990A through 990D may be a D-type flip-flop operated according to the clock clk. The multiplexer 985A, 985B, 985C, and 985D receives at its first input an output (e.g., stored value) of the storage element 990A, 990B, 990C, and 990D, respectively, and receives at its second input the data signal “data_in [0]”, “data_in [1]”, “data_in [2]”, and “data_in [3]”, respectively. The multiplexer 985A, 985B, 985C, and 985D selects/provides at its output the input signal at its first input when “data_enable” is not asserted and selects/provides at its output the input signal at its second input when “data_enable” is asserted. The output of multiplexer 985A, 985B, 985C, and 985D is provided for storage in the storage element 990A, 990B, 990C, and 990D, respectively, connected to the multiplexer 985A, 985B, 985C, and 985D, respectively.

With reference back to the AND gate 950, the AND gate 950 generates “data_enable” having logic high only when “next_count” is 0 (e.g., as determined by the comparator 945), among other conditions. If “data_enable” is asserted (e.g., logic high), “data_in [0]”, “data_in [1]”, “data_in [2]”, and “data_in [3]” are directed/routed by the multiplexer 985A, 985B, 985C, and 985D, respectively, to the storage element 990A, 990B, 990C, and 990D, respectively. If “data_enable” is not asserted, “data_in [0]”, “data_in [1]”, “data_in [2]”, and “data_in [3]” as stored in the storage elements 990A, 990B, 990C, and 990D, respectively, are directed/routed back to the storage elements 990A, 990B, 990C, and 990D, respectively, via the multiplexer 985A, 985B, 985C, and 985D, respectively. In this case, the storage elements 990A through 990D do not change in value and, as such, data flow is stalled for a clock cycle. With the data flow stalled, “count” and “next_count” may be cycled through values 0, then 1, then 2, and then 3 such that “data_in [0]”, “data_in [1]”, “data_in [2]”, and “data_in [3]” stored in the storage element 990A, 990B, 990C, and 990D, respectively, is provided as the data signal “data_out” by the multiplexer 995 when “count” provided as a select signal to the multiplexer 995 is 0, 1, 2, and 3, respectively. After “count” and “next_count” cycle back to 0, “data_enable” may be asserted and a next set of “data_in [0]”, “data_in [1]”, “data_in [2]”, and “data_in [3]” may be directed to and stored in the storage element 990A, 990B, 990C, and 990D, respectively, via the multiplexer 985A, 985B, 985C, and 985D, respectively.

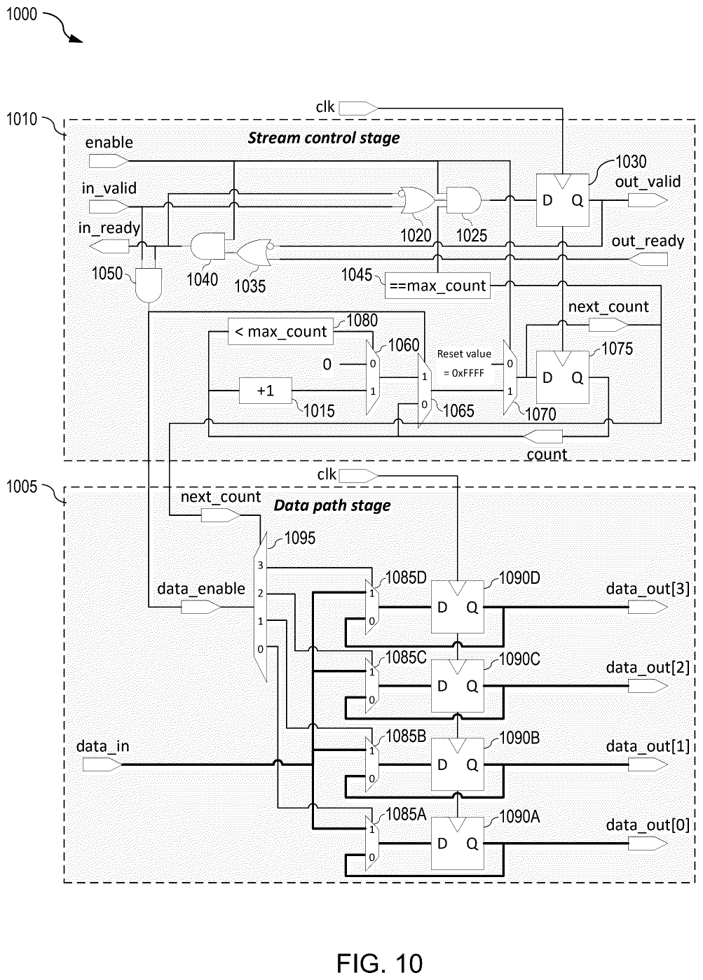

FIG. 10 illustrates a receive gearbox 1000 in accordance with one or more embodiments of the present disclosure. In an aspect, FIG. 10 may be considered as providing a flow (e.g., an atomic flow) associated with operation of the receive gearbox 1000. In some embodiments, such may be associated with operation of the receive gearbox 810 of FIG. 8. The receive gearbox 1000 includes a data path stage 1005 for driving data at an input side/port to an output side/port and a stream control stage 1010 for controlling flow of data in the data path stage 1005. The data at the input side/port is denoted as “data_in” and data at the output side/port is denoted as “data_out [0]” through “data_out [3]”. Although FIG. 10 illustrates a combination of components (e.g., multiplexers, flip-flops, combinatorial logic gates, etc.), this combination of components provides one example representation and/or implementation of the receive gearbox 1000 and the receive gearbox 1000 may be represented and/or implemented using a different combination of components. Implementation of the receive gearbox 1000 may be based on hardware and/or software. The data path stage 1005 and the stream control stage 1010 have similarities with the corresponding stages the component 600 of FIG. 6 and thus the description related to the component 600 generally applies to the receive gearbox 1000. Furthermore, the receive gearbox 1000 is a receiver-side counterpart to the transmit gearbox 900 and, as such, the description of the transmit gearbox 900 of FIG. 9 generally applies and aligns with the receive gearbox 1000.

The stream control signal 1010 is associated with input side and output side valid signals and ready signals. Each data input signal “data_in” is associated with a corresponding valid signal “in_valid” and a corresponding ready signal “in_ready”. Counter signals, denoted as “count” and “next_count”, and a maximum count signal, denoted “max_count”, control data passing from data signal “data_in” to data signals “data_in [0]” through “data_in [3]”. In this regard, the receive gearbox 1000 of FIG. 10 shows a 1-to-4 gearbox, in which, for the data path stage 1005, the “max_count”=3 to indicate a maximum value that can be assumed by “count” and “next_count”. With the “max_count”=3, each of the counter signals “count” and “next_count” cycles through (e.g., cycles periodically through) values 0, 1, 2, 3 (i.e., “max_count”), 0, 1, 2, 3, and so forth to direct “data_in” to “data_out [0]” through “data_out [3]”, as further discussed herein. Cycling of the counter signals “count” and “next_count” may be through incrementing at a block 1015. Resetting of the counter signals “count” and “next_count” to 0 may be by a block 1080 and a multiplexer 1060. It is noted that a 1-to-4 gearbox may be configured to operate as a 1-to-3 gearbox, 1-to-2 gearbox, or a 1-to-1 gearbox by setting the “max_count” to 2, 1, or 0, respectively.

An OR gate 1020 receives at its inputs the valid signal “in_valid” and an inverted version of the ready signal “in_ready”. An output of the OR gate 1020 is a logic low when the valid signal “in_valid” is not asserted (e.g., data is not valid) and the ready signal “in_ready” is asserted (e.g., transmitter is ready to transfer data). Otherwise, the output of the OR gate 1020 is a logic high.

An AND gate 1025 receives as its input the output of the OR gate 1020, an enable signal “enable” (e.g., signal to enable or disable functionality of the receive gearbox 1000), and an output of a comparator 1045 that generates a logic high output when “next_count” is equal to “max_count” and a logic low output otherwise. An output of the AND gate 1025 is a logic high when the output of the OR gate 1020 is a logic high, the enable signal “enable” is asserted (e.g., logic high), and the output of the comparator 1045 is a logic high (e.g., “next_count” is equal to “max_count”). Otherwise, the output of the AND gate 1025 is a logic low. The output of the AND gate 1025 is provided for storage in a storage element 1030 connected to the AND gate 1025. In an aspect, as shown in FIG. 10, the storage element 1030 may be a D-type flip-flop operated according to a clock clk. The storage element 1030 may provide the valid signal “out_valid” on the output side.

An OR gate 1035 receives at its inputs the ready signal “out_ready” and an inverted version of the valid signal “out_valid”. An output of the OR gate 1035 is a logic low when the valid signal “out_valid” (e.g., data is valid) is asserted and/or the ready signal “out_ready” is not asserted (e.g., transmitter is not ready to transfer data). Otherwise, the output of the OR gate 1035 is a logic high.

An AND gate 1040 receives as its inputs “enable” and the output of the OR gate 1035. An output of the AND gate 1040 is a logic high when “enable” is a logic high and the output of the OR gate 1035 is a logic high. Otherwise, the output of the AND gate 1040 is a logic low. The output of the AND gate 1040 provides the ready signal “in_ready”.

An AND gate 1050 receives at its inputs the valid signal “in_valid” and the ready signal “in_ready” and generates a data enable signal “data_enable” based on its inputs. The data enable signal “data_enable” is asserted (e.g., logic high) when, and only when, the valid signal “in_valid” (e.g., data is valid) and the ready signal “in_ready” (e.g., data is ready to be transferred) are asserted. Otherwise, the data enable signal “data_enable” is not asserted.

The counter signals “count” and “next_count” are controlled using multiplexers 1060, 1065, and 1070. The multiplexer 1060 receives at its first input a 0 and its second input an incremented value of “count” (i.e., “count”+1). The multiplexer 1060 selects/provides at its output the input signal at its first input (i.e., 0) when the output of a comparator 1080 is a logic low (e.g., “count” is great than or equal to “max_count”, although in FIG. 10 “count” can have a value of at most equal to “max_count”) and selects/provides at its output the input signal at its second input when the comparator 1080 is a logic high (e.g., “count” is less than “max_count”).

The multiplexer 1065 receives at its first input “count” and at its second input the output of the multiplexer 1060. The multiplexer 1065 selects/provides at its output the input signal at its first input (i.e., “count”) when the output of the AND gate 1055 (i.e., “data_enable”) is a logic low and selects/provides at its output the input signal at its second input when the output of the AND gate 1050 is a logic high.

The multiplexer 1070 receives at its first input a reset value and at its second input the output of the multiplexer 1065. The multiplexer 1070 selects/provides at its output the input signal at its first input when “enable” is not asserted (e.g., logic low) and selects/provides at its output the input signal at its second input when “enable” is asserted (e.g., logic high). The output of the multiplexer 1070 provides the signal “next_count”. The output of multiplexer 1070 is provided for storage in a storage element 1075 connected to the multiplexer 1070. In an aspect, as shown in FIG. 10, similar to the storage element 1030, the storage element 1075 may be a D-type flip-flop operated according to the clock clk. The storage element 1075 receives “next_count” as input, stores “next_count”, and provides “next count” as “count” (e.g., with timing provided according to the clock signal clk). As such, the multiplexers 1060, 1065, and 1070 collectively cause “count” and “next_count” to cycle through values 0, 1, 2, 3 (i.e., “max_count”), 0, 1, 2, 3, and so forth and cause “count” and “next_count” to be reset (e.g., set to a reset value such as 0xFFFF in FIG. 10) when “enable” is not asserted.

The data path stage 1005 includes a demultiplexer 1095, multiplexers 1085A through 1085D, and storage elements 1090A through 1090D. In an aspect, each of the storage elements 1090A through 1090D may be a D-type flip-flop operated according to the clock clk. The demultiplexer 1095 receives at its input “data_enable” and provides its input to a selected one of its outputs based on “next_count” which is provided as a select signal to the demultiplexer 1095. When “next_count” is 0, 1, 2, or 3, “data_enable” is provided as a select signal to the multiplexer 1085A, 1085B, 1085C, or 1085D, respectively.

The multiplexer 1085A, 1085B, 1085C, and 1085D receives at its first input an output (e.g., stored value) of the storage element 1090A, 1090B, 1090C, and 1090D, respectively, and receives at its second input the data signal “data_in”. The multiplexer 1085A, 1085B, 1085C, and 1085D selects/provides at its output the input signal at its first input when “data_enable” is not asserted and selects/provides at its output the input signal at its second input when “data_enable” is asserted. The output of multiplexer 1085A, 1085B, 1085C, and 1085D is provided for storage in the storage element 1090A, 1090B, 1090C, and 1090D, respectively, connected to the multiplexer 1085A, 1085B, 1085C, and 1085D, respectively.

With reference back to the AND gate 1050, the AND gate 1050 generates “data_enable” having logic high only when “next_count” is “max_count” (e.g., as determined by the comparator 1045 and provided to the AND gate 1025), among other conditions. If “data_enable” is asserted (e.g., logic high), “data_in” is directed/routed, one at a time as controlled by the demultiplexer 1095, by the multiplexer 1085A, 1085B, 1085C, and 1085D, respectively, to the storage element 1090A, 1090B, 1090C, and 1090D, respectively. If “data_enable” is not asserted, “data_in” as stored in the storage elements 1090A, 1090B, 1090C, and 1090D, respectively, are directed/routed back to the storage elements 1090A, 1090B, 1090C, and 1090D, respectively, via the multiplexer 1085A, 1085B, 1085C, and 1085D, respectively. In this case, the storage elements 1090A through 1090D do not change in value and, as such, data flow is stalled. With the data flow stalled, “count” and “next_count” cycle through values, 0, then 1, then 2, and then 3 (i.e., “max_count”) such that “data_in” is stored in the storage element 1090A, 1090B, 1090C, and 1090D, respectively, when “next_count” is 0, 1, 2, and 3, respectively. When “count” and “next_count” cycles back to “max_count”, “data_enable” may be asserted and “data_in” may be provided as a next set of “data_out [0]”, “data_out [1]”, “data_out [2]”, and “data_out [3]”.

FIGS. 11A and 11B illustrate an example of an elastic buffer 1100 having deterministic latency in accordance with one or more embodiments of the present disclosure. In some embodiments, the elastic buffer 1100 may be, may include, may implement, and/or may be a part of the elastic buffer 412 of the transmit datapath 405 of FIG. 4, the transmit-side elastic buffer 705 of FIG. 7, the elastic buffer 462 of the receive datapath 410 of FIG. 4, and/or the receive-side elastic buffer 805 of FIG. 8. In this regard, in some embodiments, one or more elastic buffers 1100 may form a part of or be coupled to a datapath architecture of a PCS circuit (e.g., the PCS circuit 400 of FIG. 4). One or more elastic buffers 1100 may form a part of or be coupled to a transmit datapath of the datapath architecture and one or more elastic buffers 1100 may form a part of or be coupled to a receive datapath of the datapath architecture. In some aspects, such as in FIGS. 11A and 11B, the elastic buffer 1100 may be a FIFO buffer. In some cases, the elastic buffer 1100 may be used to perform clock phase compensation. The phase compensation may resolve clock phase difference between its read side and write side.

The elastic buffer 1100 includes synchronous D-type flip flips (sync dffs) 1105A-D, D-type flip flips 1110A-E, a set-reset flip flop 1115, 2-input 1-output multiplexers (2-to-1 MUXs) 1120A-G, binary to gray code converters (bin2gc) 1130A and 1130B, gray code to binary converters (gc2bin) 1135A-D, incrementing blocks 1140A and 1140B, subtractor blocks 1145A and 1145B, comparators 1150A-D, an inverter 1155, AND gates 1160A-I, OR gates 1165A-C, a 1-input N-output demultiplexer (1-to-N DEMUX) 1170, and an N-input 1-output multiplexer (N-to-1 MUX) 1175. Although FIGS. 11A and 11B illustrates a combination of components (e.g., multiplexers, flip-flops, combinatorial logic gates, etc.), this combination of components provides one example representation and/or implementation of the elastic buffer 1100 and the elastic buffer 1100 may be represented and/or implemented using a different combination of components. Implementation of the elastic buffer 1100 may be based on hardware and/or software.

Various signals associated with operation of the elastic buffer 1100 are shown in FIGS. 11A and 11B. Signals and storage elements associated with write port logic and a write clock domain are shown with hash-marked tags and hash-marked flip-flop clock inputs. Signals and storage elements associated with read port logic and a read clock domain are shown with shaded-in tags and shaded-in flip-flop clock inputs. Further in this regard, some signals associated with a write port include “wr” and some signals associated with a read port include “rd” although there may be other signals associated with the write port and the read port that do not include “wr” and “rd”, respectively. A cross clock domain occurs when a signal goes from the write clock domain to the read clock domain, or vice versa. It is noted that “wr_data” and others in FIGS. 11A and 11B and other figures, may represent data paths/busses over which the corresponding signals are transferred over and/or received from, registers within which these signals may be stored, and so forth, in addition to representing the signals themselves.

A write clock “wr_clk” is provided to all storage elements in the write clock domain (e.g., the DFFs 1110A and 1110C-E and the synchronous DFF 1105C). A read clock “rd_clk” is provided to all storage elements in the read clock domain (e.g., the DFF 1110B, the SR flip flop 1115, and the synchronous DFFs 1105A, 1105B, and 1105D). In some embodiments, a status in the read clock domain may be measured and a status in the write clock domain may be measured. Uncertainty is generally introduced by a clock domain crossing element, in which a signal crosses from the read clock domain to the write clock domain or from the write clock domain to the read clock domain.

A latency control signal “latency_ctrl” may be used to control an amount of latency. In general, “latency_ctrl” may be set based on application (e.g., latency-requirements associated with a desired application). In this regard, the latency may be determined and also controlled. In some cases, “latency_ctrl” may be a multi-bit signal. Various signals may be monitored to provide an indication of the latency and/or allow for a determination of the latency associated with the elastic buffer 1100. In FIGS. 11A and 11B, such signals may include “latency_ctrl”, “fifo_mid_point”, “num_words_rdside”, and “num_words_wdside”. The latency may indicate a status of the elastic buffer 1100, such as whether it is currently half full, currently less than half full, currently more than half full, and so forth. Although in FIGS. 11A and 11B “latency_ctrl” signal is set to a midpoint of a buffer “fifo_mid_point”, “latency_ctrl” may be set to a value lower or higher than the midpoint of the buffer dependent on application (e.g., latency-requirements associated with a desired application). In some implementations, “latency_ctrl” may be a fixed (e.g., non-adjustable, non-reprogrammable) value. In other implementations, “latency_ctrl” may be adjustable. As an example, if the FIFO can store up to 1,000 entries, the “latency_ctrl” may be set to a value between 0 and 1,000, inclusive, the elastic buffer 1100 may store up to the number of entries set by “latency_ctrl” before starting to read out these entries and remove these entries after read out. In some cases, “latency_ctrl”, “fifo_mid_point”, “num_words_rdside”, and “num_words_wrside” may be stored in registers (e.g., software-readable registers) and monitor read and write ports of the elastic buffer 1100 for facilitating deterministic latency. In this regard, the “latency_ctrl”, “fifo_mid_point”, “num_words_rdside”, and “num_words_wrside” may be coupled to control and/or observation ports and read out for processing and/or storage for latency purposes and/or other purposes.

In some embodiments, monitoring of “latency_ctrl”, “fifo_mid_point”, “num_words_rdside”, and “num_words_wrside” may allow a phase between the read and write clocks of the elastic buffer 1100 to be determined, thus supporting a synchronous datapath architecture having a deterministic latency. In some embodiments, each elastic buffer 1100 that forms a part of or is coupled to a transmit datapath of a datapath architecture and each elastic buffer 1100 that forms a part of or is coupled to a receive datapath of the datapath architecture have “latency_ctrl”, “fifo_mid_point”, “num_words_rdside”, and “num_words_wrside” signals that are monitored. In other words, such signals are monitoring in all instances of elastic buffers associated with a given datapath architecture. In some embodiments, as further described herein, “num_words_wrside” and “num_words_rdside” provide the same measurement but from different clock domains. In this regard, using two vantage points (e.g., write side versus read side), a difference between “num_words_wrside” and “num_words_rdside” is indicative of an actual latency between the read and write pointers may be determined. In some aspects, a determination of the actual latency based on the difference may involve initial characterization with different phase shifts of the read and write clocks. After characterization, a read out of “num_words_wrside” and “num_words_rdside” may be used (e.g., directly used) to look up a corresponding phase difference and thus the actual latency. As such, the latency is deterministic.

With reference primarily first to the write port signals, a write enable signal “wr_enable” may be considered a valid signal that, when asserted, indicates presence of valid data to be written/transferred to the elastic buffer 1100. This valid signal may be a valid signal received by the elastic buffer 1100 from a component upstream of the elastic buffer 1100 that provides data to the elastic buffer 1100. In an embodiment, the elastic buffer 1100 may be, may include, may implement, and/or may be a part of the elastic buffer 412 of the transmit datapath 405 that receives data (e.g., PIPE data, such as from the gearbox 710) to be written into the elastic buffer 1100 and then subsequently read out from the elastic buffer 1100 for processing by components downstream of the elastic buffer 412. In an embodiment, the elastic buffer 1100 may be, may include, may implement, and/or may be a part of the transmit-side elastic buffer 705 that receives data (e.g., “plc_data”) to be written into the elastic buffer 1100 and then subsequently read out from the elastic buffer 1100 for processing by components downstream of the transmit-side elastic buffer 705. In an embodiment, the elastic buffer 1100 may be, may include, or may be a part of the elastic buffer 462 of the receive datapath 410 that receives data to be written into the elastic buffer 462 and then subsequently read out from the elastic buffer 462 (e.g., provided as “rx_pipe_data”) for processing by components downstream of the elastic buffer 462. In an embodiment, the elastic buffer 1100 may be, may include, may implement, and/or may be a part of the receive-side elastic buffer 805 that receives data to be written into the receive-side elastic buffer 805 and then subsequently read out from the receive-side elastic buffer 805 for processing by components downstream of the receive-side elastic buffer 805. Data may be written at a memory location associated with a write pointer “wr_prt”. Data to be read out may be at a memory location associated with a read pointer “rd_ptr”.

A number of words stored in the elastic buffer 1100 as determined by the write side, denoted as “num_words_wrside” and whose determination is discussed further herein, is provided to the comparator 1150A. An output of the comparator 1150A is provided as a buffer state signal “wr_fifo_full” indicating whether the elastic buffer 1100 is full or not full. The output of the comparator 1150A may be a logic high when num_words_wrside≥N (e.g., the elastic buffer 1100 can store words having indices 0, 1, 2, . . . , N−1) indicating the elastic buffer 1100 is full and a logic low when num_words_wrside<N indicating the elastic buffer 1100 is not full. The “wr_fifo_full” signal may be considered a ready signal from this elastic buffer 1100 to an upstream component transferring data to the elastic buffer 1100. When the elastic buffer 1100 is full, the upstream component receives the “wr_fifo_full” signal at a logic high indicating the elastic buffer is full and to not send data to the elastic buffer 1100. The AND gate 1160B receives at its inputs “wr_fifo_full” and “wr_enable” and generates a buffer state signal “wr_fifo_overflow” based on its inputs to indicate whether the elastic buffer 1100 is in an overflow condition. In this regard, the elastic buffer 1100 is in the overflow condition if the elastic buffer 1100 is full and the write enable “wr_enable” signal is asserted to indicate presence of additional data to be written to the elastic buffer 1100. The “wr_fifo_overflow” signal is provided back to the synchronous DFF 1105B. It is noted that flow control may be designed appropriately such that the elastic buffer 1100 generally avoids getting into an overflow situation. The AND gate 1160C receives at its inputs an inverted version of the “wr_fifo_full” signal and the “wr_enable” signal and generates a buffer state signal “wr_fifo” indicating the elastic buffer 1100 can receive/store incoming data. The “wr_fifo” is a logic high when the elastic buffer 1100 is not full and the “wr_enable” signal is a logic high to indicate data is to be transferred to the elastic buffer 1100. Otherwise, the “wr_fifo” is a logic low.

The demultiplexer 1170 receives at its input the “wr_fifo” signal and provides its input to a selected one of its outputs based on the write pointer “wr_ptr”. The write pointer “wr_ptr” has a value that indicates a current memory location at which to write incoming data. In this regard, a value of the “wr_ptr” at any given time (e.g., any given clock cycle) may be a memory location associated with a 0th, 1st, 2nd, . . . , (N−2)^{nd}, or (N−1)^{st} entry of the elastic buffer 1100. When “wr_ptr” is indicative of a 0th, kth, or (N−1)^{st} entry, “wr_fifo” is provided as a select signal to the multiplexer 1120G, 1120F, or 1120E, respectively. Ellipses between 0, k, and N−1 in the demultiplexer 1170 and the multiplexer 1175 indicate that one or more additional indices are present between 0 and k and/or between k and N−1 or no indices are between 0 and k and/or between k and N−1. Similarly, ellipses between each multiplexer-DFF pair (e.g., between a pair formed of the multiplexer 1120E and the DFF 1110C and a pair formed of the multiplexer 1120F and the DFF 1110D, or between a pair formed of the multiplexer 1120F and the DFF 1110D and a pair formed of the multiplexer 1120G and the DFF 1110E) indicate that one or more multiplexer-DFF pairs are present or no multiplexer-DFF pairs are present.

The multiplexer 1120E, 1120F, and 1120G receives at its first input the “wr_data” signal to be written into the elastic buffer 1100 and receives at its second input an output (e.g., stored value) of the DFF 1110C, 1110D, and 1110E, respectively. The write pointer “wr_ptr” enables one of the multiplexers 1120E, 1120F, 1120G, or other multiplexer not shown in FIG. 11B to select/provide at its output the “wr_data” to the DFF 1110C, 1110D, 1110E, or other DFF not shown in FIG. 11B that corresponds to the enabled multiplexer. For example, when the “wr_ptr” has a value indicative of a kth entry of the elastic buffer 1100, the “wr_ptr” signal enables the multiplexer 1120F and causes the multiplexer 1120F to provide the “wr_data” to the DFF 1110D. Data flow is stalled for the remaining multiplexer-DFF pairs.

The read pointer “rd_ptr” has a value that indicates a current memory location at which to read stored data. In this regard, a value of the “rd_ptr” at any given time (e.g., any given clock cycle) may be a memory location associated with a 0th, 1st, 2nd, . . . , (N−2)^{nd}, or (N−1)^{st} entry of the elastic buffer 1100. The multiplexer 1175 receives at its inputs the output (e.g., stored value) of the DFFs 1110C, 1110D, 1110E, and any other DFFs not shown in FIGS. 11A and 11B associated with data transferred to the elastic buffer 1100 for storage. When “rd_ptr” is indicative of a 0th, kth, or (N−1)^{st} entry of the elastic buffer 1100, the output of the DFF 1110E, 1110D, or 1110C, respectively, is provided as an output of the multiplexer 1175. The output of the multiplexer 1175 is the “rd_data” signal (e.g., the data read out of the elastic buffer 1100).

With reference to the read port signals, a read enable signal “rd_enable” may be considered as a ready signal indicating a readiness of a component downstream of the elastic buffer 1100 to receive data read out from the elastic buffer 1100.

A number of words stored in the elastic buffer 1100 as determined by the read side, denoted as “num_words_rdside” and whose determination is discussed further herein, is provided to the comparators 1150B-D. An output of the comparator 1150B may be a logic high when the “num_words_rdside” is equal to zero and a logic low otherwise. An output of the comparator 1150C may be a logic high when “num_words_rdside”≥ “latency_ctrl” (e.g., where “latency_ctrl”=“fifo_mid_point” in FIGS. 11A and 11B) and may be a logic low otherwise. An output of the comparator 1150D may be a logic high when “num_words_rdside”≥ “latency_ctrl” (e.g., where “latency_ctrl”=“fifo_mid_point” in FIGS. 11A and 11B) and may be a logic low otherwise.

In some embodiments, “num_words_wrside” and “num_words_rdside” provide the same measurement but from different clock domains. In this regard, using two vantage points (e.g., write side versus read side), a difference between “num_words_wrside” and “num_words_rdside” is indicative of an actual latency between the read and write pointers and may be determined. In some aspects, a determination of the actual latency based on the difference may involve initial characterization with different phase shifts of the read and write clocks. After characterization, a read out of “num_words_wrside” and “num_words_rdside” may be used (e.g., directly used) to look up a corresponding phase difference and thus the actual latency. As such, the latency is deterministic.

The multiplexer 1120D receives a signal “fifo_startup” as its select signal, the output of the comparator 1150B at its first input, and an inverted version (e.g., inverted by the inverter 1155) of the output of the comparator 1150C at its second input. As further described herein, when the “fifo_startup” is asserted (e.g., a logic high), the elastic buffer 1100 has stored a sufficient number of entries (e.g., at least the number indicated by “latency_ctrl”) such that the elastic buffer 1100 can begin read out of its stored entries, and when the “fifo_startup” is a logic low, the elastic buffer 1100 may continue to receive entries of data without reading out the entries. The output of the multiplexer 1120D is denoted as “rd_fifo_empty”. When the “fifo_startup” is asserted, the multiplexer 1120D selects/provides at its output the input signal at its second input, which is the output of the inverter 1155. When “fifo_startup” is a logic high and the output of the comparator 1150C is a logic high (and thus the output of the inverter 1155 is a logic low), “rd_fifo_empty” is a logic low since “num_words_rdside” is non-zero (e.g., specifically “num_words_rdside”≥“fifo_mid_point” as indicated by the comparator 1150C). When “fifo_startup” is a logic high and the output of the comparator 1150C is a logic low (and thus the output of the inverter 1155 is a logic high), “rd_fifo_empty” is a logic high. When the “fifo_startup” is not asserted, the multiplexer 1120D selects/provides at its output the input signal at its first input, which is the output of the comparator 1150B indicating whether or not “num_words_rdside” is zero. When “num_words_rdside” is zero, “rd_fifo_empty” is a logic high indicating the elastic buffer 1100 is empty. When “num_words_rd” is not zero, “rd_fifo_empty” is a logic low indicating the elastic buffer 1100 is not empty. When the elastic buffer 1100 is empty, there is no data to be transferred/read out of the elastic buffer 1100 and, as such, any data seen at an output of the elastic buffer 1100 is not valid. As such, the “rd_fifo_empty” signal may be considered (e.g., a logic equivalent of) a valid signal indicating whether data is valid. In some cases, the “wr_clear”, “rd_clear”, “fifo_startup_done”, and “fifo_startup” signals may be used to get FIFO functionality started at a time of data transfer. In some embodiments, the elastic buffer 1100 may provide data to a gearbox. Using various embodiments, by controlling a start of data transfer from the elastic buffer 1100 to the gearbox at a known initial state and running the gearbox by a single clock, the state of the gearbox at any point in time is predictable.

The AND gate 1160F receives at its inputs the “rd_enable” signal and an inverted version of the “fifo_startup” signal. An output of the AND gate 1160F is provided as an input signal to the AND gate 1160G. The output of the AND gate 1160F is a logic high when the “rd_enable” signal is a logic high and the “fifo_startup” signal is a logic low. Otherwise, the output of the AND gate 1160A is a logic low.

The AND gate 1160G receives at its inputs the output of the comparator 1150B and the output of the AND gate 1160F. An output of the AND gate 1160G provides a signal “rd_fifo_underflow” indicating whether the elastic buffer 1100 is in an underflow condition. The “rd_fifo_underflow” signal is a logic high when the output of the comparator 1150B is a logic high (e.g., “num_words_rdside”=0) and the output of the AND gate 1160F is a logic high (e.g., “rd_enable” is a logic high and “fifo_startup” signal is a logic low). An underflow may occur when a downstream component requests data from the elastic buffer 1100 when the elastic buffer 1100 is empty, as illustrated by the cascade of conditions set forth by the AND gates 1160F and 1160G. The “rd_enable” is from a downstream port and may be considered a ready signal indicating the downstream port is ready to receive data from the elastic buffer.

The AND gate 1160I receives at its inputs the “rd_enable” signal and an inverted version of the output of the comparator 1150B. An output of the AND gate 1160I is a logic high when the “rd_enable” signal is asserted and the output of the comparator 1150B is a logic low (e.g., “num_words_rdside” does not equal 0). Otherwise, the output of the AND gate 1160I is a logic low otherwise.

The AND gate 1160H receives at its inputs the “fifo_startup” signal and the output of the comparator 1150D. An output of the AND gate 1160H is a logic high when the “fifo_startup” signal is a logic high and the output of the comparator 1150D is a logic high (e.g., “num_words_rdside”>“latency_ctrl”). Otherwise, the output of the AND gate 1160H is a logic low.

The OR gate 1165B receives at its inputs the output of the AND gates 11601 and 1160H. The OR gate 1165B provides a signal “rd_fifo” as its output. The “rd_fifo” is a logic high when the “fifo_startup” signal is a logic high and the output of the comparator 1150D is a logic high (e.g., “num_words_rdside”>“latency_ctrl”) as provided by the AND gate 1160H, or when the “rd_enable” signal is a logic high and the output of the comparator 1150B is a logic low (e.g., “num_words_rdside” does not equal 0) as provided by the AND gate 1160I.

The AND gate 1160D receives at its inputs the “rd_fifo” signal and an inverted version of a “rd_skip” signal. An output of the AND gate 1160D is a logic high when the “rd_fifo” signal is a logic high and the “rd_skip” signal is a logic low. Otherwise, the output of the AND gate 1160D may be a logic low.

The multiplexer 1120B receives the output of the AND gate 1160D as a select signal, a pointer signal “rd_ptr_gc” stored in and provided by the DFF 1110B at its first input, and a pointer signal “next_rd_ptr_gc” at its second input. The “next_rd_ptr_gc” signal is generated by incrementing the “rd_ptr” signal (e.g., moving the “rd_ptr” to a memory address associated with a next entry) using the incrementing block 1140B and converting the incremented “rd_ptr” signal from a binary code to a gray code using the binary to gray code converter 1130B. The multiplexer 1120B selects/provides at its output the “rd_ptr_gc” signal (e.g., the current read pointer position) at its first input when the output of the AND gate 1160D is a logic low and selects/provides at its output the “next_rd_ptr_gc” signal (e.g., the next read pointer position) at its second input when the output of the AND gate 1160D is a logic high.

The synchronous DFF 1105A receives a “wr_clear” signal and synchronizes the “wr_clear” signal to the read domain clock to obtain a “fifo_clear_rdside” signal. The synchronous DFF 1105 receives the “wr_fifo_overflow” signal, which is associated with the write domain clock, and synchronizes the “wr_fifo_overflow” signal to the read domain clock to obtain a “fifo_overflow_rdside” signal.

The OR gate 1165A receives at its inputs an “rd_clear” signal, the “fifo_clear_rdside” signal, and the “fifo_overflow_rdside” signal. An output of the OR gate 1165A may be a logic low when the “rd_clear” signal, the “fifo_clear_rdside” signal, and the “fifo_overflow_rdside” signal are each logic low. Otherwise, the output of the OR gate 1165B may be a logic high.

The multiplexer 1120C receives the output of the synchronous DFF 1105D as its select signal, the output of the multiplexer 1120B as its first input, and the output of the OR gate 1165A as its second input. When the output of the OR gate 1165A is a logic high, the output of the multiplexer 1120C is a gray code version of the “wr_ptr_rdside” signal from the synchronous DFF 1105D. In this regard, the “rd_ptr_gc” signal is reset to match the gray code version of the “wr_ptr_rdside” signal. When the output of the OR gate 1165A is a logic low, the output of the multiplexer 1120C is the output of the multiplexer 1120B.

The DFF 1110B stores the output of the multiplexer 1120C. An output of the DFF 1110B is provided as the read pointer signal “rd_ptr_gc”. In this regard, through operation of the multiplexers 1120B and 1120C and associated logic (e.g., the OR gate 1165A and the AND gate 1160D), the “rd_ptr_gc” remains unchanged, is set to a next read pointer position, or is reset to match a corresponding write pointer (e.g., the gray code version of the “wt_ptr_rdside” signal). The “rd_ptr_gc” signal is a gray code signal indicating a read pointer value, represented using a gray code value, for a current clock cycle according to the read domain clock. The “rd_ptr_gc” signal is provided to the multiplexer 1120B, the synchronous DFF 1105C, and the gray code to binary converter 1135B.

The synchronous DFF 1105C receives the “rd_ptr_gc” signal, which is associated with the read domain clock, and synchronizes the “rd_ptr_gc” signal to the write domain clock. The gray code to binary converter 1135C receives, from the synchronous DFF 1105C, the “rd_ptr_gc” signal, now synchronized to the write domain clock, to obtain a “rd_ptr_wrside” signal. In this regard, the signal provided by the synchronous DFF 1105C may be referred to as a gray code equivalent of the “rd_ptr_wrside”. The “rd_ptr_gc” signal is a binary code signal indicating a read pointer value for a current clock cycle according to the write domain clock. The comparator 1145A generates a difference between the “wr_ptr” signal and the “rd_ptr_wrside” signal to obtain the “num_words_wrside” signal. In an aspect, the “num_words_wrside” signal provides an indication of a number of words stored in the elastic buffer 1100.

The synchronous DFF 1105D receives the “wr_ptr_gc” signal, which is associated with the write domain clock, and synchronizes the “wr_ptr_gc” signal to the read domain clock. The gray code to binary converter 1135D receives, from the synchronous DFF 1105D, the “wr_ptr_gc”, now synchronized to the read domain clock, to obtain a “wr_ptr_rdside” signal. In this regard, the signal provided by the synchronous DFF 1105D may be referred to as a gray code equivalent of the “wr_ptr_rdside”. Through operation of the multiplexer 1120A and associated logic (e.g., the AND gate 1160A), the “wr_ptr_gc” either remains unchanged or is set to a next write pointer position. The gray code to binary converter 1135B converts the “rd_ptr_gc” signal to obtain the “rd_ptr” signal (e.g., a binary code representation of the “rd_ptr_gc” signal). The comparator 1145B generates a difference between the “rd_ptr” signal and the “wr_ptr_rdside” signal to obtain the “num_words_rdside” signal. In an aspect, the “num_words_rdside” signal provides an indication of a number of words stored in the elastic buffer 1100.

The AND gate 1160E receives at its inputs the “rd_enable” signal and the output of the comparator 1150C. An output “fifo_startup_done” of the AND gate 1160E may be a logic high when the “rd_enable” signal is asserted (e.g., the component downstream of the elastic buffer 1100 is ready to receive data read out from the elastic buffer 1100) and the output of the comparator 1150C is a logic high (e.g., “num_words_rdside”≥“latency_ctrl”). Otherwise, the output of the AND gate 1160E may be a logic low. When the “fifo_startup_done” is a logic high, the elastic buffer 1100 has stored a sufficient number of entries (e.g., at least the number indicated by “latency_ctrl”) such that the elastic buffer 1100 can begin FIFO functionality to read out its stored entries. In some cases, the “wr_clear”, “rd_clear”, “fifo_startup_done”, and “fifo_startup” signals may be used to get FIFO functionality started at a time of data transfer.

The AND gate 1160A receives at its input the “wr_fifo” signal and an inverted version of a write skip signal “wr_skip”. An output of the AND gate 1160A is provided as a select signal to the multiplexer 1120A. The output of the AND gate 1160A is a logic high when the “wr_fifo” signal is a logic high and the “wr_skip” signal is a logic low. Otherwise, the output of the AND gate 1160A is a logic low.

The multiplexer 1120A receives at its first input an output (e.g., stored value) of the DFF 1110A and at its second input a pointer signal “next_wr_ptr_gc”. The “next_wr_ptr_gc” signal is generated by incrementing the “wr_ptr” signal (e.g., moving the “wr_ptr” to a memory address associated with a next entry) using the incrementing block 1140A and converting the incremented “wr_ptr” signal from a binary code to a gray code using the binary to gray code converter 1130A. The multiplexer 1120A selects/provides at its output the input signal at its first input when the output of the AND gate 1160A is a logic low and selects/provides at its output the input signal at its second input (i.e., the “next_wr_ptr_gc” signal). The DFF 1110A stores the output of the multiplexer 1120A. An output of the DFF 1110A is provided as a write pointer signal “wr_ptr_gc”. The “wr_ptr_gc” signal is a gray code signal indicating a write pointer value, represented using a gray code value, for a current clock cycle according to the write domain clock.

The gray code to binary converter 1135A and the synchronous DFF 1105D receive as input the “wr_ptr_gc” signal. The gray code to binary converter 1135A converts the “wr_ptr_gc” signal to obtain the “wr_ptr” signal (e.g., a binary code representation of the “wr_ptr_gc” signal). The synchronous DFF 1105D receives the “wr_ptr_gc” signal and synchronizes the “wr_ptr_gc” signal to the read domain clock. In this regard, the synchronous DFF 1105D may be considered a clock domain crossing element in which the “wr_ptr_gc” signal crosses from the write clock domain to the read clock domain. The synchronous DFF 1105D provides the “wr_ptr_gc” signal, now synchronized to the read clock domain, to the gray code to binary converter 1135. The gray code to binary converter 1135 converts the “wr_ptr_gc” signal, now synchronized to the read clock domain, to obtain a write pointer signal “wr_ptr_rdside” as determined from the read side (e.g., from the vantage point of the read clock domain). In some cases, the FIFO may be labeled asynchronous, since the same logic may be applied for non-isochronous clocks. However, if the clocks are non-asynchronous, latency monitoring circuits may show a drift rather than an indication of deterministic phase difference.

The “rd_skip” and “wr_skip” signals provide fine granularity of flow control. In some protocols, such as PCIe and Ethernet, a transmitter and a receiver are not connected to the same clock source and may have some slight drift. The protocol may make provisions to, from time to time, send extra characters to fill up time. If there is too much data arriving, data associated with an asserted “rd_skip” or “wr_skip” may be skipped because the data is just filler. Wr_skip is synchronous with the write clock. Rd_skip is synchronous with the read clock. On transmit side and receive side, it is known which data can be skipped (e.g., whether to jump off one clock cycle or not) and thus remains deterministic.

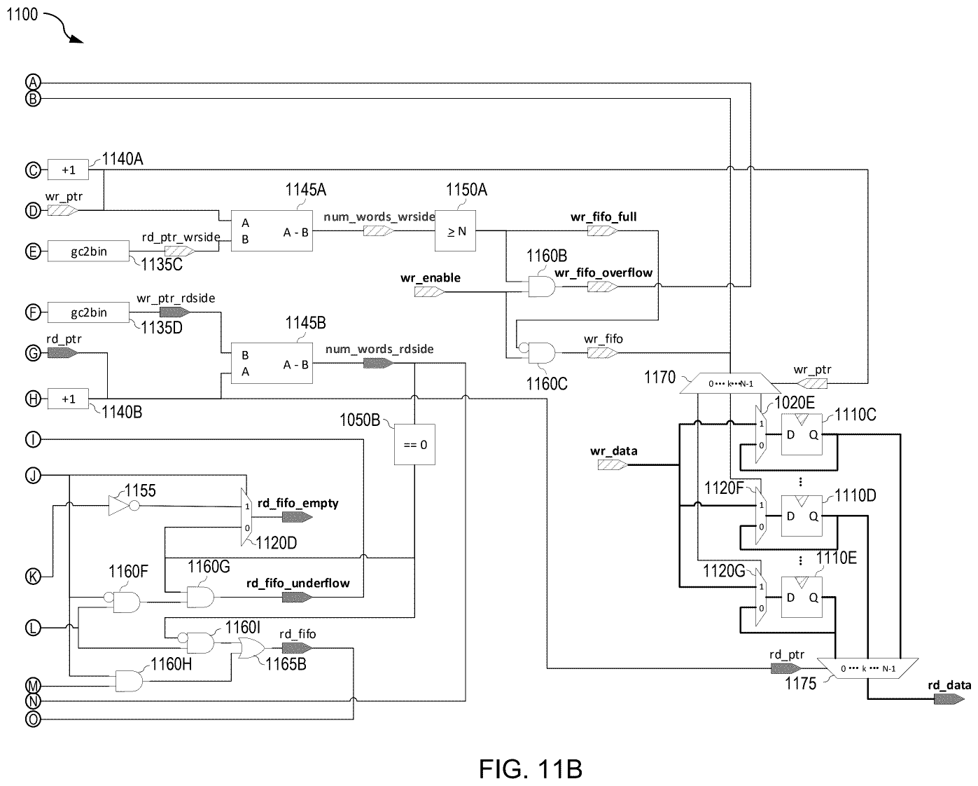

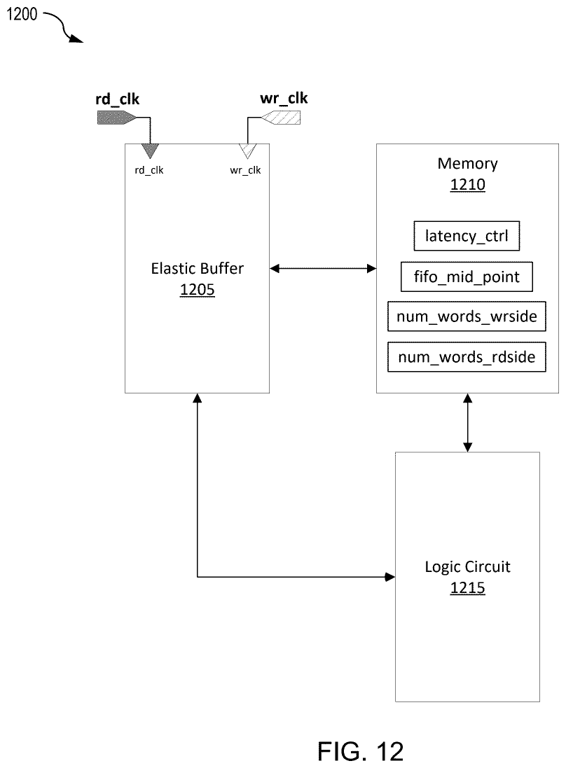

FIG. 12 illustrates a block diagram of a system 1200 for facilitating deterministic latency in accordance with one or more embodiments of the present disclosure. The system 1200 includes an elastic buffer 1205, a memory 1210, and a logic circuit 1215. In some embodiments, the elastic buffer 1100 may implement the elastic buffer 1205. In some embodiments, the elastic buffer 1205 may be, may include, and/or may be a part of the elastic buffer 412 of the transmit datapath 405 of FIG. 4, the transmit-side elastic buffer 705 of FIG. 7, the elastic buffer 462 of the receive datapath 410 of FIG. 4, and/or the receive-side elastic buffer 805 of FIG. 8.

The elastic buffer 1205 may operate according to a read clock “rd_clk” and a write clock “wr_clk”. The elastic buffer 1205 may store (e.g., write) data at a memory location of the elastic buffer 1205 associated with a write pointer (e.g., the “wr_ptr” signal) and transfer data stored at a memory location of the elastic buffer 1205 associated with a read pointer (e.g., the “rd_ptr” signal). In an aspect, a latency of the elastic buffer 1205 may be, or may be based on, a difference between the write pointer and the read pointer. The elastic buffer 1205 may include ports to facilitate sending/retrieval of the “latency_ctrl”, “fifo_mid_point”, “num_words_wrside”, and “num_words_rdside” signals. These signals may correspond to those shown and described with respect to the elastic buffer 1100 of FIGS. 11A and 11B. These signals may be stored in registers (e.g., software-readable registers) of the memory 1210. The logic circuit 1215 and/or other circuit may retrieve one or more of these signals. In some aspects, alternatively or in addition to storing the “latency_ctrl”, “fifo_mid_point”, “num_words_wrside”, and “num_words_rdside” signals in the memory 1210 for retrieval by the logic circuit 1215, the logic circuit 1215 may retrieve one or more of the “latency_ctrl”, “fifo_mid_point”, “num_words_wrside”, and “num_words_rdside” signals directly from the elastic buffer 1205.

The logic circuit 1215 may determine a phase difference between the read and write clocks based on a difference between “num_words_wrside” and “num_words_rdside”. In this regard, this difference is indicative of an actual latency between the read and write pointers. In some aspects, a determination of the actual latency based on the difference may involve initial characterization with different phase shifts of the read and write clocks. After characterization, a read out of “num_words_wrside” and “num_words_rdside” may be used (e.g., directly used) to look up a corresponding phase difference and thus the actual latency. As such, the latency is deterministic.

Although the system 1200 includes a single elastic buffer, the logic circuit 1215 and/or the memory 1210 may be coupled to one or more additional elastic buffers (e.g., to receive and/or process signals “latency_ctrl”, “fifo_mid_point”, “num_words_wrside”, and/or “num_words_rdside” from each elastic buffer) and/or the system 1200 may include one or more additional logic circuits and/or memories to support the additional elastic buffer(s). Furthermore, although not explicitly shown in other figures, a circuit such as the logic circuit 1215 and/or other logic circuits may be coupled to components of a transmit datapath (e.g., 405), components of a receive datapath (e.g., 410), and/or generally any component of an overall datapath architecture (e.g., 400) to facilitate operation of these components.

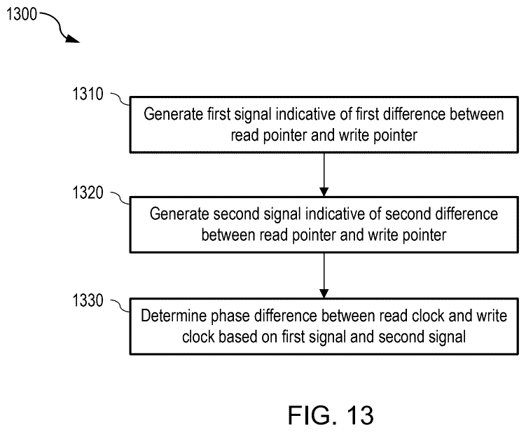

FIG. 13 illustrates a flow diagram of an example process 1300 for facilitating deterministic latency in accordance with one or more embodiments of the present disclosure. Although, for explanatory purposes, the process 1300 is described with reference to the elastic buffer 1100 and the system 1200, the process 1300 may be performed by other elastic buffers and/or systems. Note that one or more operations may be combined, omitted, and/or performed in a difference order as desired.

In operation 1310, the elastic buffer 1205 generates a first signal associated with a write domain and indicative of a first difference between a read pointer of associated with the elastic buffer 1205 and a write pointer associated with the elastic buffer 1205. The elastic buffer 1205 operates according to a read clock “rd_clk” associated with a read domain of the elastic buffer 1205 and a write clock “wr_clk” associated with a write domain of the elastic buffer 1205. In an aspect, the read clock and the write clock have the same clock rate. With reference to FIGS. 11A, 11B, and 12, the first signal may be the “num_words_wrside” signal that indicates a number of words stored in the elastic buffer 1205 as determined by a write side (e.g., associated with the write domain and the write clock) of the elastic buffer 1205. In some cases, the elastic buffer 1205 may include a subtractor (e.g., the subtractor block 1145A) that generates the first signal by performing a subtraction between a third signal (e.g., the “wr_ptr” signal of FIGS. 11A and 11B) and a fourth signal (e.g., the “rd_ptr_wrside” signal of FIGS. 11A and 11B), in which the third signal is associated with the write clock and is indicative of the write pointer and the fourth signal is associated with the write clock and is indicative of the read pointer.

In operation 1320, the elastic buffer 1205 generates a second signal associated with the read domain and indicative of a second difference between the read pointer of associated with the elastic buffer 1205 and the write pointer associated with the elastic buffer 1205. With reference to FIGS. 11A, 11B, and 12, the second signal may be the “num_words_rdside” signal that indicates a number of words stored in the elastic buffer 1205 as determined by a read side (e.g., associated with the read domain and the read clock) of the elastic buffer 1205. In some cases, the elastic buffer 1205 may include a subtractor (e.g., the subtractor block 1145B) that generates the second signal by performing a subtraction between a fifth signal (e.g., the “wr_ptr_rdside” signal of FIGS. 11A and 11B) and a sixth signal (e.g., the “rd_ptr” signal of FIGS. 11A and 11B), in which the fifth signal is associated with the read clock and is indicative of the write pointer and the sixth signal is associated with the read clock and is indicative of the read pointer. As shown with reference to FIGS. 11A and 11B, converters such as gray code to binary converters and binary to gray code converters may be utilized as appropriate to convert signals to the appropriate representation.

In operation 1330, the logic circuit 1215 determines a phase difference between the read clock and the write clock based on the first signal and the second signal. As provided above, the first signal (e.g., “num_words_wrside”) and the second signal (e.g., “num_words_rdside”) provide the same measurement but from different clock domains. Using two vantage points (e.g., write side versus read side), a difference between the first signal and the second signal is indicative of an actual latency between the read and write pointers and may be determined. In some aspects, a determination of the actual latency based on the difference may involve initial characterization with different phase shifts of the read and write clocks. After characterization, the logic circuit 1215 may determine the phase difference based on a read out of the first signal (e.g., “num_words_wrside”) and the second signal (e.g., “num_words_rdside”) to look up the corresponding phase difference and thus the actual latency. As such, the latency is deterministic.

In some aspects, a subtraction between a third signal (e.g., the “wr_ptr” signal of FIGS. 11A and 11B) and a fourth signal (e.g., the “rd_ptr_wrside” signal of FIGS. 11A and 11B) is performed in operation 1310 and a subtraction between a fifth signal (e.g., the “wr_ptr_rdside” signal of FIGS. 11A and 11B) and a sixth signal (e.g., the “rd_ptr” signal of FIGS. 11A and 11B) is performed in operation 1320. Both the difference between “wr_ptr” and “rd_ptr_wrside” and the difference between “wr_ptr_rdside” and “rd_ptr” are differences between a write pointer and a read pointer, with the phase difference between the read and write clocks being based on a difference between these two differences of the write pointer and the read pointer.

As shown for example in FIGS. 4, 7, and 8, the elastic buffer 1205 may transfer data to a gearbox or receive data from a gearbox. Using various embodiments, clock domain crossings are implemented only in elastic buffers, such as the elastic buffer 1205. The gearbox is devoid of any clock domain crossings. In this regard, the gearbox is devoid of any clock domain crossing from the read domain to the write domain and is devoid of any clock domain crossing from the write domain to the read domain.

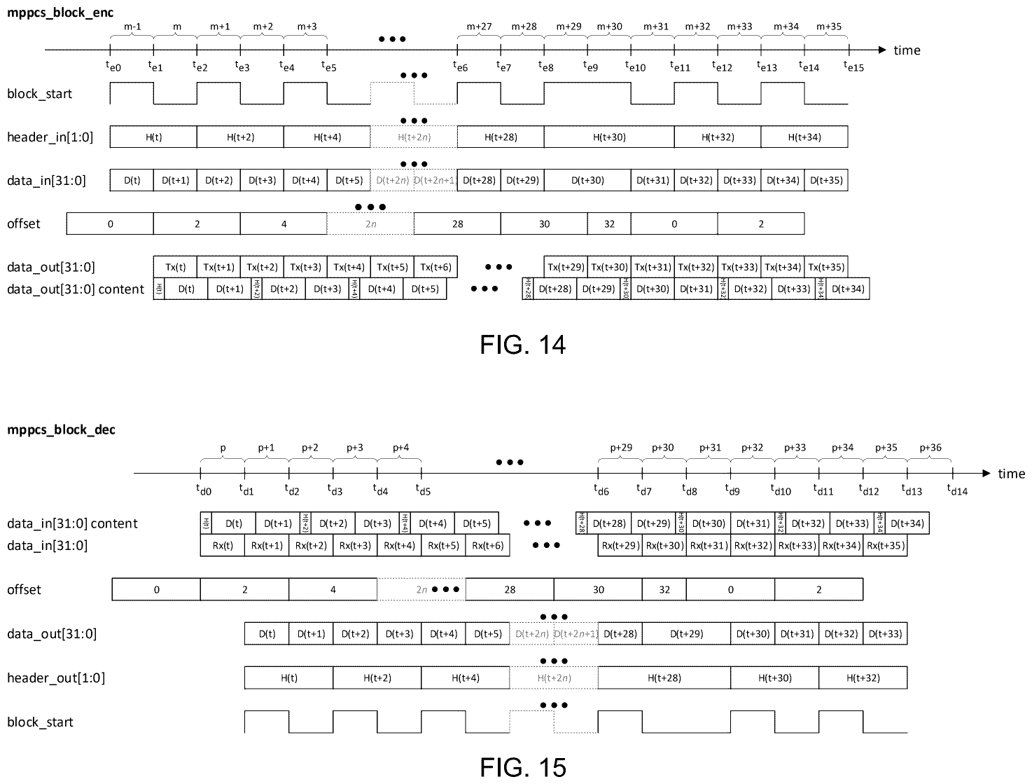

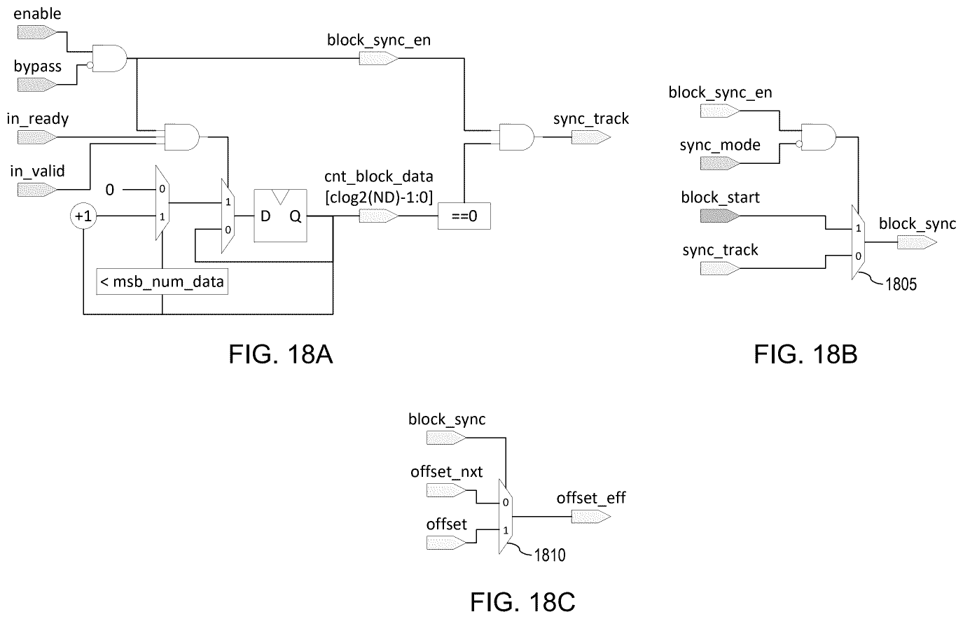

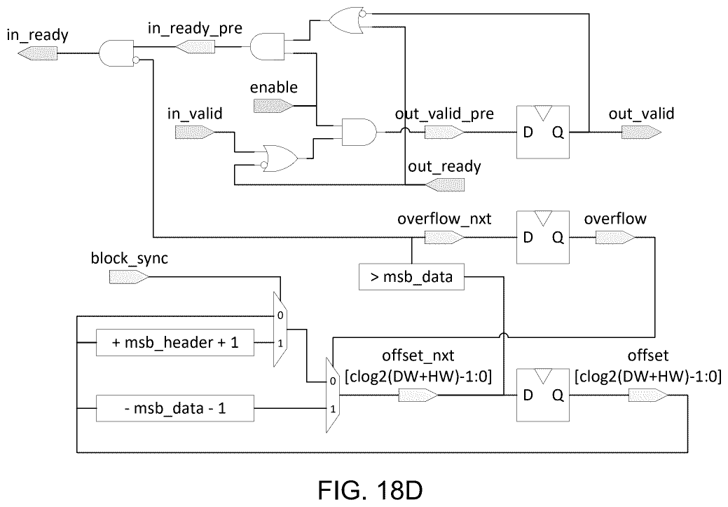

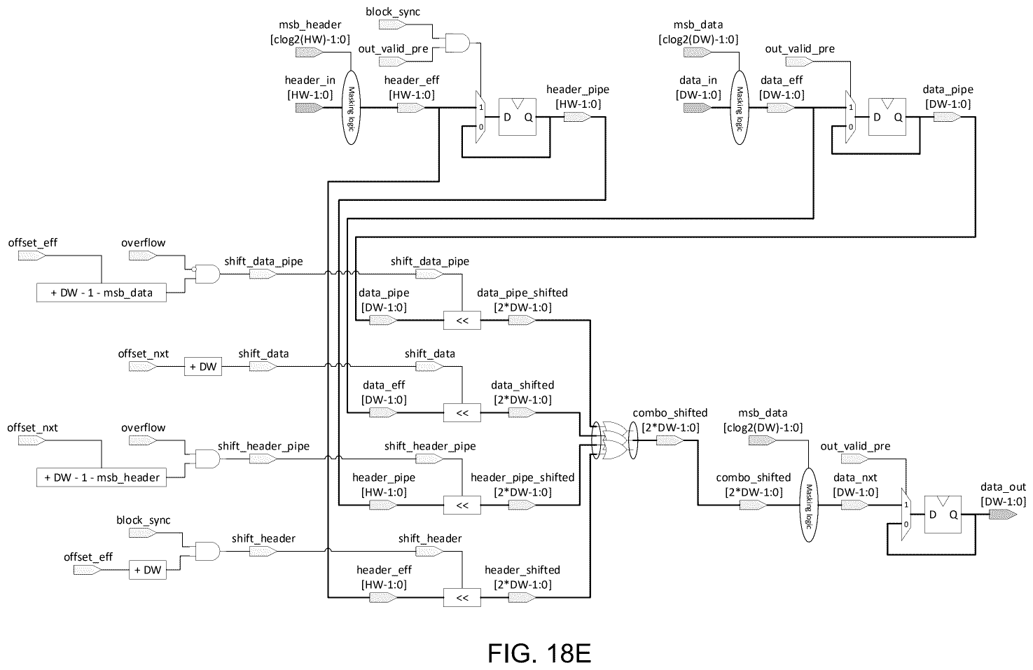

FIG. 14 illustrates a timing diagram and associated dataflow and control signals associated with a block encoder for facilitating deterministic latency in accordance with one or more embodiments of the present disclosure. In some embodiments, and for explanatory purposes, data is provided as blocks of 64-bits (e.g., 64-bit wide data blocks), such as according to an Ethernet protocol, and transmitted via a datapath that is 32 bit wide. In an embodiment, the block encoder may be, may include, or may be a part of the block encoder 422 of FIG. 4. In an embodiment, an example of a block encoder that operates with signals “block_start”, “header_in”, “data_in” “offset”, and “data_out” is described further herein with respect to FIGS. 18A through 18E. As such, two clock cycles are needed to transfer one block of data using this datapath. In this regard, a time between tₑ₀ and tₑ₁ is an (m−1)^{st} clock cycle, between tₑ₁ and tₑ₂ is an mth clock cycle, between tₑ₂ and tes is an (m+1)^{st} clock cycle, between tₑ₁₂ and tₑ₁₃ is an (m+33) rd clock cycle, between tₑ₁₃ and tₑ₁₄ is an (m+34)^{th} clock cycle, and so forth, where m is an arbitrary integer value. In other embodiments, data may be provided as blocks of fewer or more than 64 bits and/or the datapath may be narrower or wider than 32 bits.

The block encoder receives and processes (e.g., encodes) “data_in” signals D(t), D(t+1), D(t+2), D(t+3), D(t+34), D(t+35), and so forth. Each of D(t), D(t+1), D(t+2), D(t+3), D(t+34), D(t+35), etc. is a 32-bit “data_in” signal. The block encoder generates 2-bit headers (e.g., 2-bit synchronization headers) for each data block that provides information associated with the data block. In this regard, each of H(t), H(t+2), H(t+34), and so forth is a 2-bit “header_in” signal. Since each data block is 64 bits, two “data_in” signals form a single 64-bit data block that is associated with a corresponding “header_in” signal that provides information associated with the data block. Rising edges of the signal “block_start” (e.g., at tₑ₀, tₑ₂, tₑ₄, tₑ₆, tₑ₈, tₑ₁₁, and tₑ₁₃) are associated with a start of a new data block. The “block_start” signal is asserted (e.g., logic high) during the clock cycle(s) when the “data_in” signal is an initial 32-bits of a 64-bit data block transferred via the 32-bit data bus. Otherwise, the “block_start” signal is deasserted (e.g., logic low). As examples, D(t) and D(t+1) together form one data block that is associated with header H(t), D(t+2) and D(t+3) together form one data block that is associated with header H(t+2), D(t+30) and D(t+31) together form one data block that is associated with header H(t+32), D(t+32) and D(t+33) together form one data block that is associated with header H(t+32), and so forth. In an embodiment, the block encoder may be, may include, or may be a part of the block encoder 422 of FIG. 4 or the block encoder 514 of FIG. 5 and the “data_in” signals received by the block encoder may be based on processed data from a gearbox upstream of the block encoder 422 or 514, such as the gearbox 710 of FIG. 7. In this regard, the processed data from the gearbox 710 may be further processed, such as by the elastic buffer 412, the formatter 414, and/or the scrambler 416 and then this further processed data provided as input to the block encoder 422 for processing by the block encoder 422 to generate data outputs “data_out”.

The block encoder generates reformatted data signals “data_out” by merging the “data_in” signals with the corresponding “header_in” signals on the same 32-bit data bus. Each reformatted data output Tx(•) is 32 bits and includes data and/or header. Each reformatted data output Tx(•) is transferred/transmitted over the 32-bit data bus in one clock cycle. As shown in FIG. 14, content of Tx(t) includes a header H(t) and a portion of D(t); Tx(t+1) includes a portion of D(t) and a portion of D(t+1); Tx(t+2) includes a portion of D(t+1), a header H(t+2), and a portion of D(t+2); Tx(t+31) includes D(t+30); Tx(t+34) includes a portion of D(t+32) and a portion of D(t+33); Tx(t+35) includes a portion of D(t+33), header H(t+34), and a portion of D(t+34); and so forth.

Specifically, with regard to Tx(t), Tx(t+1), and Tx(t+2) for example, portions of D(t) are transferred over two clock cycles (i.e., mth and (m+1)^{st} clock cycles) and portions of D(t+1) are transferred over two clock cycles (i.e., (m+1)^{st} and (m+2)^{nd} clock cycles). Tx(t) includes the 2-bit header H(t) and 30-bits of the data D(t), Tx(t+1) includes the remaining 2 bits of the data D(t) and 30 bits of the data D(t+1), and Tx(t+2) includes the remaining 2 bits of the data D(t+1), the 2-bit header H(t+2), and 28 bits of the data D(t+2). In this regard, with respect to Tx(t) and Tx(t+1), transmission of the last two bits of the data D(t) is shifted to a next clock cycle (e.g., to the (m+1)^{st} clock cycle).

An offset signal “offset” provides an indication of a number of bits that data is offset by in a data output Tx(•) due to merging of data and header. As one example, an offset of 2 associated with (e.g., coinciding in time and clock cycles with) Tx(t) and Tx(t+1) indicates that data D(t) contained in Tx(t) and data D(t+1) contained in Tx(t+1) are offset by 2 bits due to merging of data and header. In Tx(t), the header H(t) forms a zeroth and a first bit of Tx(t), with a zeroth bit of the data D(t) positioned at a second bit of Tx(t) and thus associated with an offset of 2 bits. In Tx(t+1), the last two bits of the data D(t) form a zeroth and a first bit of Tx(t+1), with a zeroth bit of the data D(t+1) positioned at a second bit of Tx(t+1) and thus associated with an offset of 2 bits. As another example, an offset of 4 associated with Tx(t+2) and Tx(t+3) indicates that data contained in Tx(t+2) and Tx(t+3) are offset by 4 bits due to merging of data and header. In Tx(t+2), the last two bits of the data D(t+1) form a zeroth and a first bit of Tx(t+2) and the header H(t+2) forms a second and a third bit of Tx(t+2), with a zeroth bit of the data D(t+2) positioned at a fourth bit of Tx(t+2) (and thus associated with an offset of 4). In Tx(t+3), the last four bits of the data D(t+2) form zeroth through third bits of Tx(t+3), with a zeroth bit of the data D(t+3) positioned at a fourth bit of Tx(t+3).

As examples, the various signals shown in FIG. 14 are described with reference to the clock cycles. Prior to an (m−1)^{st} clock cycle, the block encoder may be handling no data or data that arrived prior to D(t) arriving. During an (m−1)^{st} clock cycle, the “data_in” signal of the block encoder is held at D(t) and the corresponding “header_in” signal of the block encoder is held at H(t). During an mth clock cycle, the “data_in” signal of the block encoder is held at D(t+1) and the corresponding “header_in” signal of the block encoder continues to be held at H(t). The block encoder transfers the “data_out” signal Tx(t) during the mth clock cycle, during which the “offset” is held at 2 to indicate the “data_in” signal D(t) contained in Tx(t) is offset by two bits due to the merging of data and header. During an (m+1)^{st} clock cycle, the “data_in” signal of the block encoder is held at D(t+2) and the corresponding “header_in” signal of the block encoder is held at H(t+2). The block encoder transfers the “data_out” signal Tx(t+1) during the (m+1)^{st} clock cycle, during which the “offset” is held at 2 to indicate the “data_in” signal D(t+1) contained in Tx(t+1) is offset by two bits. During an (m+2)^{nd} clock cycle, the “data_in” signal of the block encoder is held at D(t+3) and the corresponding “header_in” signal of the block encoder continues to be held at H(t+2). The block encoder transfers the “data_out” signal Tx(t+2) during the (m+2)^{nd} clock cycle, during which the “offset” is held at 4 to indicate the “data_in” signal D(t+2) contained in Tx(t+2) is offset by four bits.

With each offset of two due to merging of data blocks and headers, eventually a cumulative shift of 32 bits occurs in which the “data_in” is offset by a full 32-bit data D(•), as described with reference to the following clock cycles. During an (m+29)^{th} clock cycle, the “data_in” signal of the block encoder is held at D(t+30) and the corresponding “header_in” signal of the block encoder is held at H(t+30). The block encoder transfers the “data_out” signal Tx(t+29) during the (m+29)^{th} clock cycle, during which the “offset” is held at 30 to indicate the “data_in” signal D(t+29) contained in Tx(t+29) is offset by 30 bits. During an (m+30)^{th} clock cycle, the “data_in” signal of the block encoder continues to be held at D(t+30) and the corresponding “header_in” signal of the block encoder continues to be held at H(t+30). The block encoder transfers the “data_out” signal Tx(t+30) during the (m+30)^{th} clock cycle, during which the “offset” during the (m+30)^{th} clock cycle is held at 32 to indicate the “data_in” signal D(t+30) is offset by 32 bits and thus not in Tx(t+30). In this regard, Tx(t+30) includes the remaining 30 bits of D(t+29) and the two-bit header H(t+30). During an (m+31)^{st} clock cycle, the “data_in” signal of the block encoder is held at D(t+31) and the corresponding “header_in” signal of the block encoder continues to be held at H(t+30). The block encoder transfers the “data_out” signal Tx(t+31) during the (m+31)^{st} clock cycle, during which the “offset” during the (m+31)^{st} clock cycle is held at 0 to indicate the “data_in” signal D(t+30) contained in Tx(t+31) is offset by 0 bits. In this regard, the “block_start” signal is asserted (e.g., logic high) for an additional clock cycle and the “data_in” signal D(t+30) and its corresponding “header_in” H(t+30) continue to be held for an additional clock cycle (e.g., “block_start” asserted for two clock cycles, “data_in” held at D(t+30) for two clock cycles, “header_in” held at H(t+30) for three clock cycles) due to the offset of 32 bits during the (m+30)^{th} clock cycle. Relative to D(t+30) and H(t+30), the next “data_in” signal D(t+31) and next “header_in” signal H(t+32) may be delayed by one clock cycle from being provided to the block encoder by an upstream component. The block encoder does not receive any new data “data_in” or new header “header_in” during the (m+30)^{th} clock cycle. In some aspects, when the offset reaches 32, the block encoder may deassert a ready signal and send this deasserted ready signal (e.g., a ready signal having a value of logic low) to the upstream component that provides the “data_in” signals to the block encoder. The upstream component delays sending data until the ready signal is asserted. In this regard, the offset may be used to facilitate synchronous operation of the block encoder and, more generally, the datapath along with the block encoder resides.

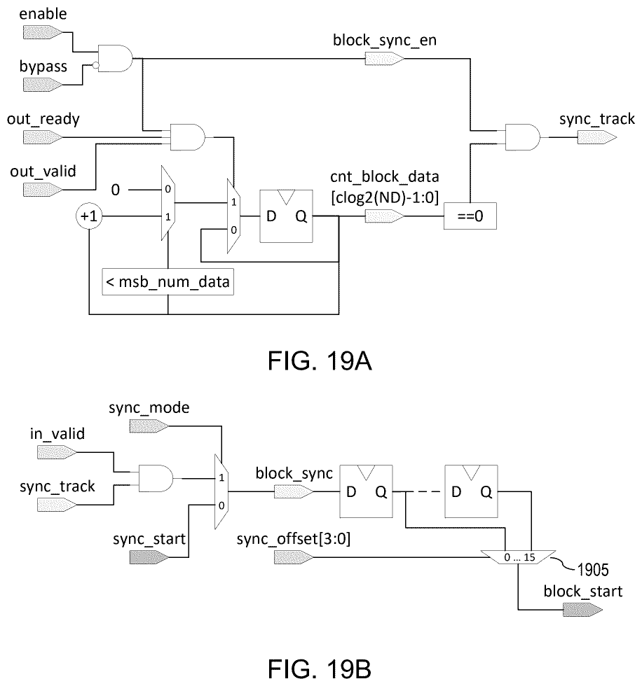

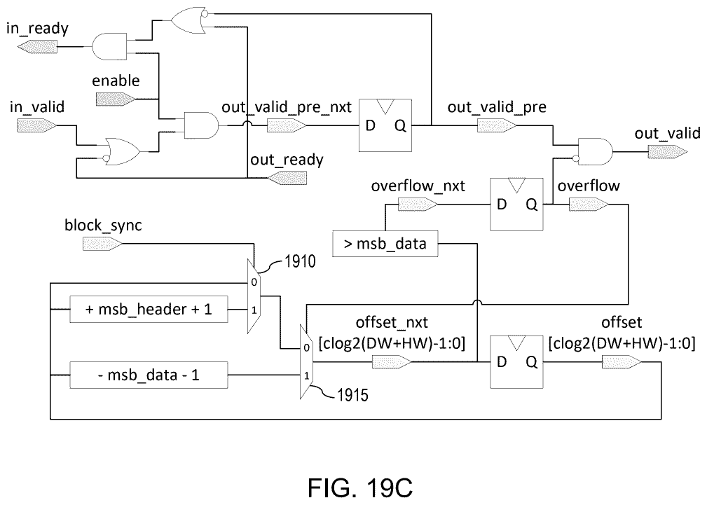

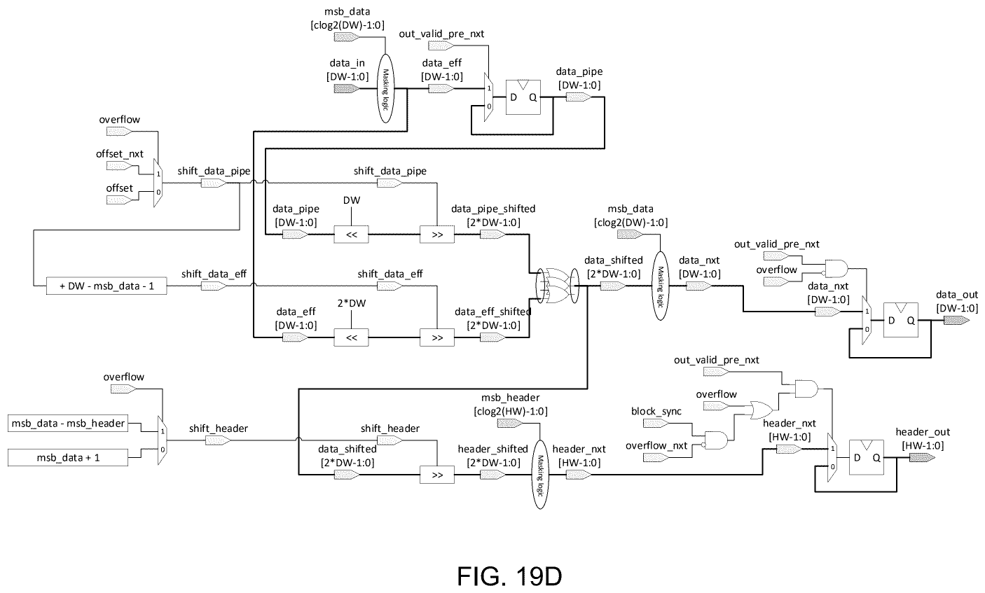

FIG. 15 illustrates a timing diagram and associated dataflow and control signals associated with a block decoder for facilitating deterministic latency in accordance with one or more embodiments of the present disclosure. In some embodiments, and for explanatory purposes, data is received via a 32-bit wide datapath and data blocks are 64-bits wide. In an embodiment, the block decoder may be, may include, or may be a part of the block decoder 472 of FIG. 4. In an embodiment, an example of a block decoder that operates with signals “data_in”, “offset”, “data_out”, “header_out”, and “block_start” is described further herein with respect to FIGS. 19A through 19D. In other embodiments, data may be provided as blocks of fewer or more than 64 bits and/or the datapath may be narrower or wider than 32 bits. The block decoder characterized by the timing diagram and associated dataflow and control signals of FIG. 15 may be the decoding counterpart to the block encoder characterized by the timing diagram and associated dataflow and control signals of FIG. 15.

The block decoder receives formatted data signals “data_in” Rx(•) that are each 32 bits and includes data and/or header. Each data input Rx(•) is received via the 32-bit data bus in one clock cycle. The block decoder receives and decodes each “data_in” signal Rx(•) to provide each 32-bit “data_out” signal D(•) and each 2-bit “header_out” signal H(•). Rising edges of the signal “block_start” (e.g., at t_{d1}, t_{d3}, t_{d5}, t_{d6}, t_{d9}, and t_{d11}) are associated with a start of a new data block. The signal “block_start” remains asserted (e.g., logic high) during the clock cycle(s) when the “data_out” signal is an initial 32-bits of a 64-bit data block for transfer via the 32-bit data bus. Otherwise, the “block_start” signal is deasserted (e.g., logic low). Two “data_out” signals (e.g., D(t+2) and D(t+3)) form a single data block that is associated with a “header_out” signal (e.g., H(t+2)). As shown in FIG. 15, content of the received “data_in” signal Rx(t) includes a header H(t) and a portion of D(t); Rx(t+1) includes a portion of D(t) and a portion of D(t+1); Rx(t+2) includes a portion of D(t+1), a header H(t+2), and a portion of D(t+2); Rx(t+29) includes a portion of D(t+28) and D(t+29); Rx(t+30) includes a portion of D(t+29) and a header H(t+30); Rx(t+31) includes D(t+30); Rx(t+35) includes a portion of D(t+33), a header H(t+34), and a portion of D(t+34); and so forth. In an embodiment, the block decoder may be, may include, or may be a part of the block decoder 472 of FIG. 4 or the block decoder 564 of FIG. 5 and the “data_in” signals received by the block decoder may be based on processed data from a component upstream of the block decoder 472 or 564, such as the word align block 480 of FIG. 4. An offset signal “offset” provides an indication of a number of bits of data is offset by in a data input Rx(•) due to merging of data and header. As one example, an offset of 2 associated with (e.g., coinciding in time and clock cycles with) Rx(t) and Rx(t+1) indicates that data D(t) contained in Rx(t) and data D(t+1) contained in Rx(t+1) are offset by 2 bits due to merging of data and header. In Rx(t), the header H(t) forms a zeroth and a first bit of Rx(t), with a zeroth bit of the data D(t) positioned at a second bit of Tx(t) and thus associated with an offset of 2 bits. In Rx(t+1), the last two bits of the data D(t) form a zeroth and a first bit of Rx(t+1), with a zeroth bit of the data D(t+1) positioned at a second bit of Rx(t+1) and thus associated with an offset of 2 bits.

As examples, the various signals shown in FIG. 15 are described with reference to the clock cycles. Prior to a p^{th} clock cycle, the block decoder may be handling no data or data that arrived prior to Rx(t) arriving. During a p^{th} clock cycle, the block decoder receives the “data_in” signal Rx(t). The “offset” is held at 2 to indicate the “data_out” signal D(t) contained in Rx(t) is offset by two bits due to the merged data and header in Rx(t). During a (p+1)^{st} clock cycle, the block decoder receives the “data_in” signal Rx(t+1). The “offset” is held at 2 to indicate the “data_out” signal D(t+1) contained in Rx(t+1) is offset by two bits. The “data_out” signal of the block decoder is held at D(t) and the corresponding “header_out” signal of the block decoder is held at H(t). During a (p+2)^{nd} clock cycle, the block decoder receives the “data_in” signal Rx(t+2). The “offset” is held at 4 to indicate the “data_out” signal D(t+2) contained in Rx(t+2) is offset by four bits. The “data_out” signal of the block decoder is held at D(t+1) and the corresponding “header_out” signal of the block decoder continues to be held at H(t). During a (p+3) rd clock cycle, the block decoder receives the “data_in” signal Rx(t+3). The “offset” is held at 4 to indicate the “data_out” signal D(t+3) contained in Rx(t+3) is offset by four bits. The “data_out” signal of the block decoder is held at D(t+2) and the corresponding “header_out” signal of the block decoder continues to be held at H(t+2).

With each offset of two due to merging of data blocks and headers, eventually a cumulative shift of 32 bits occurs in which the “data_out” is offset by a full 32-bit data D(•), as described with reference to the following clock cycles. During a (p+29)^{th} clock cycle, the block decoder receives the “data_in” signal Rx(t+29). The “offset” is held at 30 to indicate the “data_out” signal D(t+29) contained in Rx(t+29) is offset by 30 bits. The “data_out” signal of the block decoder is held at D(t+28) and the corresponding “header_out” signal of the block decoder continues is held at H(t+28). During a (p+30)^{th} clock cycle, the block decoder receives the “data_in” signal Rx(t+30). The “offset” is held at 32 to indicate the “data_out” signal D(t+30) is offset by 32 bits and thus not in Rx(t+30). In this regard, Rx(t+30) includes the remaining 30 bits of D(t+29) and the two-bit header H(t+30). The “data_out” signal of the block decoder is held at D(t+29) and the corresponding “header_out” signal of the block decoder continues to be held at H(t+28). During a (p+31)^{st} clock cycle, the block decoder receives the “data_in” signal Rx(t+31). The “offset” is held at 0 to indicate the “data_out” signal D(t+30) contained in Rx(t+31) is offset by 0 bits. In this regard, the “block_start” signal is deasserted (e.g., logic low) for an additional clock cycle (e.g., indicating a delay before a new data block begins) and the “data_out” signal and the corresponding “header_out” signal continue to be held at D(t+29) and H(t+28), respectively, for an additional clock cycle (e.g., “block_start” deasserted for two clock cycles, “data_out” held at D(t+29) for two clock cycles, and “header_out” held at H(t+28) for three clock cycles) due to the offset of 32 bits during the (p+30)^{th} clock cycle. A downstream component does not receive new data from the block decoder during the (p+31)^{st} clock cycle.

At an offset of 32, no new data is available. A valid signal may be set by the block decoder based on a value of the offset. The valid signal may be deasserted (e.g., set to logic low) when the offset is 32 (e.g., merging of the headers and data blocks has caused an offset of an entire 32-bit data_in signal) to indicate to downstream circuitry/device to wait a clock cycle before next data arrives at the downstream circuitry/device. As an example, Rx(t+30) associated with an offset of 32 includes a remaining 30-bits of data D(t+29) and header H(t+30), and Rx(t+31) and Rx(t+32) associated with an offset of 0 includes an entirety of data D(t+30) and an entirety of data D(t+31), respectively. In this regard, the offset may be used to facilitate synchronous operation of the block decoder and, more generally, the datapath along with the block decoder resides.

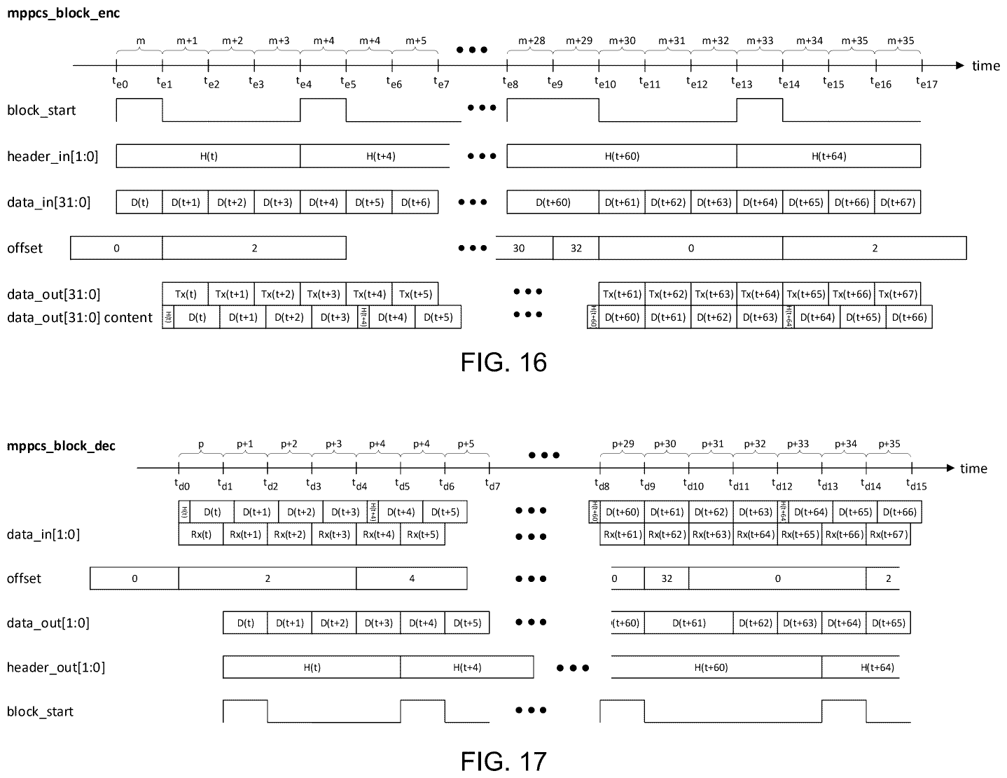

FIG. 16 illustrates a timing diagram and associated dataflow and control signals associated with a block encoder for facilitating deterministic latency in accordance with one or more embodiments of the present disclosure. In some embodiments, and for explanatory purposes, data is provided as blocks of 128-bits (e.g., 128-bit wide data blocks), and transmitted via a datapath that is 32 bits wide. In an embodiment, the block encoder may be, may include, or may be a part of the block encoder 422 of FIG. 4. In an embodiment, an example of a block encoder that operates with signals “block_start”, “header_in”, “data_in” “offset”, and “data_out” is described further herein with respect to FIGS. 18A through 18E. In other embodiments, data may be provided as blocks of fewer or more than 64 bits and/or the datapath may be narrower or wider than 32 bits.

The description of FIG. 14 generally applies to FIG. 16, with examples of differences and other description provided herein. In this regard, in FIG. 16, four clock cycles are needed to transfer one 128-bit block of data using this datapath rather than the two clock cycles needed in FIG. 14 to transfer one 64-bit block.

The block encoder receives and processes (e.g., encodes) 32-bit “data_in” signals D(t), D(t+1), D(t+66), D(t+67), and so forth. The block encoder generates 2-bit headers for each data block that provides information associated with the data block. In this regard, each of H(t), H(t+4), H(t+64), and so forth is a 2-bit “header_in” signal. Since each data block is 128 bits, four “data_in” signals form a single 128-bit data block that is associated with a corresponding “header_in” signal that provides information associated with the data block. As an example, D(t), D(t+1), D(t+2), and D(t+3) together form one data block that is associated with header H(t). Rising edges of the signal “block_start” (e.g., at tₑ₀, tₑ₄, tₑ₈, and tₑ₁₃) are associated with a start of a new data block. The “block_start” signal is asserted (e.g., logic high) during the clock cycle(s) when the “data_in” signal is an initial 32-bits of a 128-bit data block transferred via the 32-bit data bus. Otherwise, the “block_start” signal is deasserted (e.g., logic low). As described with respect to FIG. 12, an offset signal “offset” in FIG. 14 provides a number of bits that data is offset by in a data output Tx(•) due to merging of data and header and can be an even integer between 0 and 32, inclusive. In an embodiment, the block encoder may be, may include, or may be a part of the block encoder 422 of FIG. 4 and the “data_in” signals received by the block encoder may be based on processed data from a gearbox upstream of the block encoder 422, such as the gearbox 710 of FIG. 7. In this regard, the processed data from the gearbox 710 may be further processed, such as by the elastic buffer 412, the formatter 414, and/or the scrambler 416 and then this further processed data provided as input to the block encoder 422 for processing by the block encoder 422 to generate data outputs “data_out”.

FIG. 17 illustrates a timing diagram and associated dataflow and control signals associated with a block decoder for facilitating deterministic latency in accordance with one or more embodiments of the present disclosure. In some embodiments, and for explanatory purposes, data is provided as blocks of 128-bits (e.g., 128-bit wide data blocks), and transmitted via a datapath that is 32 bits wide. In an embodiment, the block decoder may be, may include, or may be a part of the block decoder 472 of FIG. 4. In an embodiment, an example of a block decoder that operates with signals “block_start”, “header_in”, “data_in” “offset”, and “data_out” is described further herein with respect to FIGS. 19A through 19D. In other embodiments, data may be provided as blocks of fewer or more than 64 bits and/or the datapath may be narrower or wider than 32 bits.

The description of FIG. 15 generally applies to FIG. 17, with examples of differences and other description provided herein. In this regard, in FIG. 17, four clock cycles are needed to receive one 128-bit block of data using this datapath rather than the two clock cycles needed in FIG. 15 to receive one 64-bit block.

The block decoder receives and processes (e.g., decodes) 32-bit “data_in” signals Rx(t), Rx(t+1), Rx(t+66), Rx(t+67), and so forth. The block decoder generates 2-bit headers for each data block that provides information associated with the data block. In this regard, each of H(t), H(t+4), H(t+64), and so forth is a 2-bit “header_out” signal. Since each data block is 128 bits, four “data_out” signals form a single 128-bit data block that is associated with a corresponding “header_out” signal that provides information associated with the data block. As an example, D(t), D(t+1), D(t+2), and D(t+3) together form one data block that is associated with header H(t). Rising edges of the signal “block_start” (e.g., at t_{d1}, t_{d5}, t_{d8}, and t_{d13}) are associated with a start of a new data block. The “block_start” signal is asserted (e.g., logic high) during the clock cycle(s) when the “data_in” signal is an initial 32-bits of a 128-bit data block transferred via the 32-bit data bus. Otherwise, the “block_start” signal is deasserted (e.g., logic low). In an embodiment, the block decoder may be, may include, or may be a part of the block decoder 472 of FIG. 4 and the “data_in” signals received by the block decoder may be based on processed data from a component upstream of the block decoder 472, such as the word align block 480 of FIG. 4.

FIGS. 18A through 18E illustrates an example of a block encoder in a transmit datapath in accordance with one or more embodiments in the present disclosure. In some embodiments, and for explanatory purposes, operation of the block encoder follows the timing diagram and associated dataflow and control signals of FIGS. 14 and/or 16. Further in this regard, for explanatory purposes, data is provided as blocks of 64-bits (e.g., 64-bit wide data blocks), such as according to an Ethernet protocol, and transmitted via a datapath that is 32 bit wide. More generally, any combination of block size and header size may be accommodated as needed for a desired application(s)/protocol(s). In this example, a data width (DW) is 32 bits and a header width (HW) is 2 bits. As an example, a DW of 32 bits and HW of 2 bits may accommodate data blocks having 64 bits of data/payload that is associated with a corresponding 2-bit header.

The block encoder operates according to the signals “data_in”, “header_in”, “data_out”, “block_start”, and “offset” shown in FIGS. 14 and 16, among other signals shown in FIGS. 18A through 18E. The “block_start” signal is associated with a “block_sync” signal via a multiplexer 1805. The “block_sync” signal is used to select an appropriate “offset” signal via a multiplexer 1810. As shown in FIG. 18E, the “offset_eff” and “offset_nxt” signals are utilized to shift “data_in” and “header_in” to obtain the data signal “data_out” of the block encoder.

FIGS. 19A through 19D illustrates an example of a block decoder in a receive datapath in accordance with one or more embodiments in the present disclosure. In some embodiments, and for explanatory purposes, operation of the block decoder follows the timing diagram and associated dataflow and control signals of FIGS. 15 and/or 17. Further in this regard, for explanatory purposes, data is provided as blocks of 64-bits (e.g., 64-bit wide data blocks), such as according to an Ethernet protocol, and transmitted via a datapath that is 32 bit wide. More generally, any combination of block size and header size may be accommodated as needed for a desired application(s)/protocol(s). In this example, DW is 32 bits and HW is 2 bits. As an example, a DW of 32 bits and HW of 2 bits may accommodate data blocks having 64 bits of data/payload that is associated with a corresponding 2-bit header.

The block decoder operates according to the signals “data_in”, “header_in”, “data_out”, “block_start”, and “offset” shown in FIGS. 15 and 17, among other signals shown in FIGS. 19A through 19D. The “block_start” signal is associated with a “block_sync” signal via a multiplexer 1905. The “block_sync” signal is used to select an appropriate “offset” signal via multiplexer 1910 and 1915. As shown in FIG. 19D, “offset” or “offset_nxt” is utilized to shift data and header to obtain the data signal “data_out” and “header_out” of the block decoder.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as program code and/or data, can be stored on one or more non-transitory machine readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the present invention. Accordingly, the scope of the invention is defined only by the following claims.

1. A physical coding sublayer (PCS) circuit comprising:
an elastic buffer configured to operate according to a read clock associated with a read domain and a write clock associated with a write domain, wherein the elastic buffer is configured to:
generate a first signal associated with the write domain and indicative of a first difference between a read pointer and a write pointer; and
generate a second signal associated with the read domain and indicative of a second difference between the read pointer and the write pointer; and
a logic circuit configured to determine a phase difference between the read clock and the write clock based on the first signal and the second signal.

2. The PCS circuit of claim 1, wherein the read clock and the write clock have the same clock rate.

3. The PCS circuit of claim 1, wherein the elastic buffer is configured to:
generate the first signal by performing a subtraction between a third signal and a fourth signal, wherein the third signal is associated with the write clock and is indicative of the write pointer, and wherein the fourth signal is associated with the write clock and is indicative of the read pointer; and
generate the second signal by performing a subtraction between a fifth signal and a sixth signal, wherein the fifth signal is associated with the read clock and is indicative of the write pointer, and wherein the sixth signal is associated with the read clock and is indicative of the read pointer.

4. The PCS circuit of claim 3, wherein the elastic buffer comprises a first synchronous flip flop configured to:
operate according to the write clock;
receive a seventh signal associated with the read clock and indicative of the read pointer; and
provide an eighth signal associated with the write clock and indicative of the read pointer, wherein the fourth signal is based on the eighth signal.

5. The PCS circuit of claim 4, further comprising a plurality of registers configured to store the first signal and the second signal;
wherein the elastic buffer is further configured to:
store data at a memory location associated with the third signal; and
transfer data stored at a memory location associated with the sixth signal;
wherein the seventh signal and the eighth signal are gray code signals;
wherein the fourth signal and the sixth signal are binary code signals; and
wherein the elastic buffer further comprises:
a gray code to binary converter configured to:
convert the eighth signal to the fourth signal; and/or
convert the seventh signal to the sixth signal; and
a second synchronous flip flop configured to:
operate according to the read clock;
receive a ninth signal associated with the write clock and indicative of the write pointer; and
provide a tenth signal associated with the read clock and indicative of the write pointer, wherein the fifth signal is based on the tenth signal.

6. The PCS circuit of claim 1, further comprising a gearbox associated with operation according to only the read clock or only the write clock, wherein the gearbox is coupled to the elastic buffer and configured to process data according to a gearbox ratio to obtain processed data.

7. The PCS circuit of claim 6, wherein the gearbox is devoid of any clock domain crossing from the read domain to the write domain and is devoid of any clock domain crossing from the write domain to the read domain.

8. The PCS circuit of claim 6, wherein the gearbox is further configured to:
provide the processed data to the elastic buffer; or
receive the data from the elastic buffer.

9. The PCS circuit of claim 6, wherein:
the gearbox is a transmit-side gearbox associated with operation according to only the read clock;
the elastic buffer is coupled to a programmable logic core (PLC);
the elastic buffer is configured to receive PLC data from the PLC and transfer the data to the gearbox; and
the data is based on the PLC data.

10. The PCS circuit of claim 9, wherein:
the elastic buffer is a first elastic buffer, the read pointer is a first read pointer, the write pointer is a first write pointer, the read clock is a first read clock, and the write clock is a first write clock;
the PCS circuit further comprises a second elastic buffer coupled to the gearbox and configured to:
operate according to a second read clock associated with the read domain and a second write clock associated with the write domain;
generate a third signal associated with the write domain and indicative of a first difference between a second read pointer and a second write pointer; and
generate a fourth signal associated with the read domain and indicative of a second difference between the second read pointer and the second write pointer; and
the logic circuit is further configured to determine a phase difference between the second read clock and the second write clock based on the third signal and the fourth signal.

11. The PCS circuit of claim 9, wherein:
the gearbox is further configured to generate a ready signal associated with receipt of the data from the elastic buffer by the gearbox;
the elastic buffer is further configured to generate a valid signal associated with transfer of the data to the gearbox; and
the elastic buffer is configured to transfer the data to the gearbox when the ready signal is asserted and the valid signal is asserted.

12. The PCS circuit of claim 9, further comprising a block encoder configured to:
transmit, to an upstream component, a ready signal associated with a data signal based at least in part on an offset, wherein the data signal is associated with the processed data;
receive, from the upstream component, a valid signal associated with the data signal;
receive, from the upstream component, the data signal when the ready signal is asserted and the valid signal is asserted; and
generate a data output signal based on the data signal, wherein the data output signal comprises a header signal and/or at least a portion of the data signal.

13. A method comprising:
generating, by an elastic buffer of a physical coding sublayer (PCS) circuit, a first signal associated with a write domain and indicative of a first difference between a read pointer and a write pointer, wherein the elastic buffer operates according to a read clock associated with a read domain and a write clock associated with the write domain;
generating, by the elastic buffer, a second signal associated with the read domain and indicative of a second difference between the read pointer and the write pointer; and
determining, by a logic circuit, a phase difference between the read clock and the write clock based on the first signal and the second signal.

14. The method of claim 13, wherein the read clock and the write clock have the same clock rate.

15. The method of claim 13, wherein:
the generating the first signal comprises performing a subtraction between a third signal and a fourth signal, wherein the third signal is associated with the write clock and is indicative of the write pointer, and wherein the fourth signal is associated with the write clock and is indicative of the read pointer; and
the generating the second signal comprises performing a subtraction between a fifth signal and a sixth signal, wherein the fifth signal is associated with the read clock and is indicative of the write pointer, and wherein the sixth signal is associated with the read clock and is indicative of the read pointer.

16. The method of claim 15, further comprising:
receiving, by a first synchronous flip flop of the elastic buffer, a seventh signal associated with the read clock and indicative of the read pointer, wherein the first synchronous flip flop operates according to the write clock;
providing, by the first synchronous flip flop, an eighth signal associated with the write clock and indicative of the read pointer, wherein the fourth signal is based on the eighth signal;
receiving, by a second synchronous flip flop of the elastic buffer, a ninth signal associated with the write clock and indicative of the write pointer, wherein the second synchronous flip flop operates according to the read clock;
providing, by the second synchronous flip flop, a tenth signal associated with the read clock and indicative of the write pointer, wherein the fifth signal is based on the tenth signal;
storing, by a plurality of registers, the first signal and the second signal;
storing, by the elastic buffer, data at a memory location indicated by the third signal; and
transferring, by the elastic buffer, data stored at a memory location indicated by the sixth signal.

17. The method of claim 13, further comprising processing, by a gearbox of the PCS circuit, data according to a gearbox ratio to obtain processed data, wherein the gearbox operates according to only the read clock or only the write clock, and wherein the gearbox is devoid of any clock domain crossing from the read domain to the write domain and is devoid of any clock domain crossing from the write domain to the read domain.

18. The method of claim 17, further comprising providing, by the gearbox, the processed data to the elastic buffer.

19. The method of claim 17, further comprising:
generating, by the gearbox, a ready signal associated with receipt of the data from the elastic buffer by the gearbox;
generating, by the elastic buffer, a valid signal associated with transfer of the data to the gearbox;
transferring, by the elastic buffer, the data to the gearbox when the ready signal is asserted and the valid signal is asserted; and
receiving, by the gearbox, the data from the elastic buffer.

20. The method of claim 17, further comprising:
transmitting, by a block encoder of the PCS circuit to an upstream component, a ready signal associated with a data signal based at least in part on an offset, wherein the data signal is associated with the processed data;
receiving, by the block encoder from the upstream component, a valid signal associated with the data signal;
receiving, by the block encoder from the upstream component, the data signal when the ready signal is asserted and the valid signal is asserted; and
generating, by the block encoder, a data output signal based on the data signal.
